(19) United States
(12) Patent Application Publication
(10) Pub. No.: US 2025/0305904 A1
(43) Pub. Date: Oct. 2, 2025

(54) SEAFLOOR LANDER APPARATUS FOR IN-SITU DETECTION AND MONITORING OF LEAKAGE EVENTS ON THE SEAFLOOR

(71) Applicant: FNV IP B.V., Leidschendam (NL)

(72) Inventors: Dickie MARTIN, Lafayette, LA (US); Carl SONNIER, Lafayette, LA (US); Jacob IRWIN, Lafayette, LA (US)

(73) Assignee: FNV IP B.V., Leidschendam (NL)

(21) Appl. No.: 18/625,026

(22) Filed: Apr. 2, 2024

(51) Int. Cl. G01M 3/24; G01S 15/42

(52) U.S. Cl. CPC G01M 3/24; G01S 15/42

(57) ABSTRACT

Described herein are systems and techniques for underwater leak detection and monitoring. Georeferenced location information of a seafloor lander can be determined based on location information of marker buoys deployed to the seafloor surface. Acoustic sensor data can be obtained from an acoustic sensor rotatably coupled to the seafloor lander, wherein the acoustic sensor is rotated through a configured angular range one or more times. An onboard processing engine of the seafloor lander can perform in-situ detection of gaseous leaks from the seafloor surface by analyzing the acoustic sensor data. A corresponding location of the gaseous leak can be determined based on the georeferenced location information of the seafloor lander and relative position information between the acoustic sensor and the one or more gaseous leaks. The seafloor lander can transmit leak detection information indicative of the one or more gaseous leaks and the corresponding location to a surface receiver.

### FIELD

The present disclosure generally relates to subsea monitoring for seep and/or leakage detection. For example, aspects of the present disclosure relate to a seafloor lander for in-situ monitoring and detection of leaks over prolonged deployment periods.

### BACKGROUND

Leakage detection can refer to the process of identifying and/or quantifying the unintended escape of fluids or gases from man-made structures (e.g., such as pipelines, wells, or storage reservoirs), natural structures (e.g., geological formations), or a combination thereof. For example, in the context of offshore operations, leakage detection may largely be focused on detecting hydrocarbon leaks (e.g., oil and natural gas) and carbon dioxide leaks from subsea infrastructure or geological storage sites.

A leak (also referred to as a leakage or leakage event) may be an unintended release of fluids or gases from a containment structure due to factors such as corrosion, mechanical damage, or improper installation. Leaks can pose significant environmental and operational risks, which may increase in severity the longer the leak remains undetected or goes without remediation. Leaks can occur due to various factors, including corrosion, mechanical damage, or improper installation. The early detection and quantification of leaks at, near, or within the seafloor marine environment can be used to provide for timely intervention and mitigation of the impacts of the leakage. For example, by accurately detecting and characterizing leaks, operators can take appropriate measures to repair the affected infrastructure, minimize environmental impacts, and ensure the safety and efficiency of offshore operations.

Various techniques can be used to perform underwater leakage detection. For example, acoustic sensors, such as side-scan sonars (SSS) and multibeam echo sounders (MBES), can be used to detect leaks based on detecting the presence of gas bubbles (e.g., released from the leak) within the water column. Acoustic sensor-based leakage detection techniques can be based on analyzing the backscatter caused by the interaction of acoustic waves with the gaseous bubbles escaping from the leak. In some examples, chemical sensors, or “sniffers,” can be used to obtain chemical measurements of the water column and thereby detect dissolved gases of interest that may be present within the water column, providing a direct indication of a leak. Chemical sensors are used to measure the physical and chemical properties of an analyte into a measurable signal, i.e. converting chemical information (such as chemical identification, concentration, pressure, or other characteristics of a chemical component) into an electrical signal to obtain qualitative or quantitative time- and spatial-resolved information about specific chemical components. The effectiveness of chemical sensors may depend on proximity to the leak source and the influence of water currents, and may require visual inspections to provide confirmation and detailed assessment of detected leaks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some examples, systems and techniques are described for underwater leak detection and monitoring by a seafloor lander apparatus. For example, a method can include: determining georeferenced location information of a seafloor lander deployed on a seafloor surface, wherein the georeferenced location information is determined based on respective location information corresponding to two or more marker buoys deployed to the seafloor surface; obtaining acoustic sensor data from an acoustic sensor rotatably coupled to the seafloor lander, wherein the acoustic sensor is rotated through a configured angular range one or more times; detecting, using an onboard processing engine of the seafloor lander, one or more gaseous leaks from the seafloor surface, wherein the one or more gaseous leaks are detected based on analyzing the acoustic sensor data using the onboard processing engine of the seafloor lander; determining a corresponding location of the one or more gaseous leaks, based on the georeferenced location information of the seafloor lander and relative position information between the acoustic sensor and the one or more gaseous leaks; and transmitting, from the seafloor lander to a surface receiver, leak detection information indicative of the one or more gaseous leaks and the corresponding location.

In some aspects, detecting the one or more gaseous leaks is performed in-situ at the seafloor surface by the onboard processing engine of the seafloor lander.

In some aspects, the onboard processing engine of the seafloor lander includes one or more trained machine learning (ML) or artificial intelligence (AI) models trained to perform leak detection.

In some aspects, a method can further include: determining, using the one or more trained ML or AI models included in the onboard processing engine, a leaked gas volume associated with the one or more gaseous leaks; obtaining additional acoustic sensor data based on one or more subsequent measurement cycles wherein the acoustic sensor is rotated to sweep through an angular sector corresponding to the location of the one or more gaseous leaks; and monitoring, based on analyzing the additional acoustic sensor data using the one or more trained ML or AI models, changes to the leaked volume associated with the one or more gaseous leaks.

In some aspects, detecting the one or more gaseous leaks from the seafloor surface is further based on obtaining chemical measurement sensor data from one or more chemical measurement sensors associated with the seafloor lander. The one or more chemical measurement sensors can be electrochemical sensors (e.g., potentiometry, amperometry, conductivity, etc.), mass sensors, optical sensors, pH sensors, magnetic sensors, and/or thermal sensors, etc., among various others. The one or more chemical sensors may comprise sensors based on semiconductive metal oxide nanostructures and/or sensors comprising two-dimensional WO₃ nanoplate components, such as Ag, In₂O₃ or PANI-modified WO₃ nanoplates or other semiconductor-based sensor components such as semiconductor oxides/graphene-based nanocomposites.

In some aspects, a periodicity associated with obtaining the chemical measurement sensor data is different from a periodicity associated with obtaining the acoustic sensor data.

In some aspects, the acoustic sensor data comprises sonar scan data and the acoustic sensor comprises one or more of a sidescan sonar, a multibeam echosounder (MBES), a scanning sonar, or a volumetric scanning sonar.

In some aspects, the acoustic sensor data comprises a plurality of measured reflections each corresponding to a sonar pulse transmitted by the acoustic sensor at a respective bearing of the acoustic sensor within the configured angular range, wherein the respective bearing is determined using a rotary encoder associated with the acoustic sensor.

In some aspects, detecting one or more gaseous leaks includes detecting a change in a leakage quantity or leakage volume associated with a previously detected gaseous leak.

In some aspects, the acoustic sensor data is obtained within a respective measurement cycle of a plurality of periodic measurement cycles performed using the acoustic sensor of the seafloor lander.

In some aspects, the seafloor lander enters a low-power mode or sleep state between consecutive measurement cycles of the plurality of periodic measurement cycles.

In some aspects, a method can further include one or more of: increasing a duration of the plurality of periodic measurement cycles in response to the onboard processing engine detecting the one or more gaseous leaks; or reducing the configured angular range for the acoustic sensor to a sector corresponding to the determined location of the one or more gaseous leaks, wherein the sector comprises a subset of the configured angular range

In some aspects, the georeferenced location information of the seafloor lander comprises a location coordinate and an orientation of the acoustic sensor; and the corresponding location of the one or more gaseous leaks is determined based on combining the georeferenced location information with the relative position information.

In some aspects, the orientation of the acoustic sensor comprises an angular offset relative to one or more of the marker buoys, and wherein the angular offset is associated with a range or distance measurement determined between the acoustic sensor and the one or more of the marker buoys.

In some aspects, the relative position information between the acoustic sensor and the one or more gaseous leaks comprises: a range determined based on the acoustic sensor data and corresponding to a distance from the acoustic sensor to the one or more gaseous leaks; and a relative bearing associated with the range.

In some aspects, the relative bearing associated with the range comprises one or more of: an angular orientation of the acoustic sensor at a time when the range is measured; or an angular offset from one or more of the marker buoys at a time when the range is measured.

In some aspects, the leak detection information is transmitted acoustically by an acoustic modem of the seafloor lander to a surface buoy.

In some aspects, transmitting the leak detection information comprises transmitting the leak detection information over a wired communication link between the seafloor lander and a tethered surface buoy, wherein the wired communication link comprises a tether coupled at a first end to the seafloor lander and coupled at a second end to the tethered surface buoy; and relaying the leak detection information over a wireless communication link from the tethered surface buoy.

In another illustrative example, a seafloor lander apparatus for in-situ leak detection is provided. The apparatus comprises at least one processor and a memory storing instructions which when executed by the at least one processor, causes the at least one processor to: determine georeferenced location information of the seafloor lander apparatus deployed on a seafloor surface, wherein the georeferenced location information is determined based on respective location information corresponding to two or more marker buoys deployed to the seafloor surface; obtain acoustic sensor data from an acoustic sensor rotatably coupled to the seafloor lander apparatus, wherein the acoustic sensor data is obtained based on rotating the acoustic sensor through a configured angular range one or more times; detect, using an onboard processing engine of the seafloor lander apparatus, one or more gaseous leaks from the seafloor surface, wherein the one or more gaseous leaks are detected based on analyzing the acoustic sensor data using the onboard processing engine; determine a corresponding location of the one or more gaseous leaks, based on the georeferenced location information and relative position information between the acoustic sensor and the one or more gaseous leaks; and transmit, from the seafloor lander apparatus to a surface receiver, leak detection information indicative of the one or more gaseous leaks and the corresponding location.

In some aspects, the at least one processor is further configured to: determine, using one or more trained machine learning (ML) or artificial intelligence (AI) models included in the onboard processing engine, a leaked gas volume associated with the one or more gaseous leaks; obtain additional acoustic sensor data based on one or more subsequent measurement cycles wherein the acoustic sensor is rotated to sweep through an angular sector corresponding to the location of the one or more gaseous leaks; and monitor, based on analyzing the additional acoustic sensor data using the one or more trained ML or AI models, changes to the leaked volume associated with the one or more gaseous leaks.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 illustrates an example of a seafloor lander apparatus for seep and/or leakage monitoring and georeferencing thereof, in accordance with some examples;

FIG. 4 is a diagram illustrating an example of a seafloor lander apparatus deployed to a seafloor environment and associated with a plurality of seabed marker buoys for positioning and georeferencing of the seafloor lander apparatus, in accordance with some examples;

FIG. 5 is a block diagram illustrating an example of leakage detection, monitoring, and reporting by an onboard processing system of a seafloor lander apparatus, in accordance with some examples;

FIG. 6. Is a block diagram illustrating an example of a seafloor lander apparatus for seep and/or leakage monitoring and georeferencing thereof, in accordance with some examples;

FIG. 7 is a block diagram illustrating an example of a deep learning (DL) machine learning network, in accordance with some examples;

FIG. 8 is a block diagram illustrating an example of a convolutional neural network (CNN), in accordance with some examples; and

FIG. 9 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Systems and techniques are described herein for in-situ sensing, detection, and/or monitoring of leakage events on the seafloor and/or within a marine environment. In one illustrative example, a seafloor lander-based system is described that can be deployed and used to provide in-situ monitoring and detection of underwater leaks, over extended periods of time (e.g., extended deployments) without the need for replenishment or external intervention to the deployed seafloor lander system.

In some embodiments, the seafloor lander can be used to detect and monitor gas leaks from subsea geological storage sites or other underwater formations or structures. For example, the seafloor lander can be deployed and used to detect and monitor carbon dioxide (CO₂) leaks from a reservoir beneath the seabed, as the CO₂ leaks first become visible at the seabed (e.g., seafloor surface). In some examples, the seafloor lander can be deployed and used to detect and monitor hydrocarbon leakage from an underwater pipeline, a wellhead, etc. In some aspects, the seafloor lander systems and techniques described herein can address a need for long-term, continuous monitoring of potential leak sites on the seafloor with minimal to zero intervention required over the deployment period of the seafloor lander system in the marine environment. The disclosed seafloor lander system can be operated over longer deployment periods, with lesser intervention and lesser cost than those respectively associated with the various, existing leakage monitoring approaches (e.g., ship-based or autonomous underwater vehicle (AUV)-based surveying).

As noted previously, leakage detection can be an important aspect of ensuring the integrity and safety of subsea infrastructure, such as oil and gas pipelines, wells, and geological carbon storage sites. Additionally, the early detection and localization of leaks can be seen to enable timely intervention and mitigation of potential environmental and operational impacts that may otherwise be caused by the leakage of CO₂, hydrocarbons, or other substance of interest for the leak detection and monitoring. Conventional approaches to underwater leakage detection often rely on acoustic sensors, such as sidescan sonars or multibeam echo sounders (MBES), mounted on surface vessels or AUVs. These systems can detect gas bubbles in the water column by analyzing the backscatter caused by the acoustic waves interacting with the bubbles. However, ship-based surveys are costly and cannot be run continuously over extended durations, and AUV surveys are constrained by battery life and require regular recharging and/or support from a manned surface vessel.

For example, a manned surface vessel may utilize one or more of a hull-mounted MBES and a towed sidescan sonar to actively survey an area and perform leak detection therein. The operation of a manned surface vessel to conduct such surveys can be costly and complex, and the monitoring is not continuous. In another example, an unmanned vessel (e.g., an unmanned surface vessel (USV)) with a hull-mounted MBES and/or towed sidescan sonar, or a sidescan sonar mounted on a remotely operated vehicle (ROV) can be used to perform a marine survey for leak detection. However, successful USV operations remain challenging, and very few USVs have yet to successfully operate a towed sidescan sonar for any time duration. USVs are additionally vulnerable to the same or similar challenges of duration cost and adverse weather impacts that are associated with using manned surface vessels to perform leak detection surveying by keeping a vessel on location for an extended deployment (e.g., for an extended period of time).

In another example, an unmanned AUV may be configured with a sidescan sonar and/or MBES sensor array and used to perform underwater surveying for leak detection. Unmanned AUVs require onboard battery power that may largely be consumed by the propulsion or drive system used to maneuver the AUV through the marine environment, and as such are duration-limited in their ability to remain on location to perform leak detection and/or related surveying of an area of seafloor for an extended deployment or extended period of time. For example, the battery-powered design of existing AUVs imposes time limitations on the underwater surveying operation of the AUV, and often requires the AUV to be deployed within range of a powered charging station and/or requires the AUV to be deployed in combination with a nearby surface vessel supporting the AUV and AUV operations.

Accordingly, the systems and techniques described herein for a seafloor lander apparatus for in-situ detection and monitoring of leakage events on the seafloor can overcome these challenges and more, based at least in part on integrating acoustic (e.g., side scan sonar, single-beam sonar, multi-beam sonar, etc.) and/or optional chemical measurement sensors on a seafloor lander platform, which can be deployed at a targeted subsea location for extended periods without requiring intervention or maintenance.

To provide accurate localization of detected leaks on the seafloor and/or within the surveyed or monitored area of the marine environment, the systems and techniques can perform relative positioning based on a plurality of seafloor marker buoys that are deployed to known locations within the surrounding environment of the seafloor lander. For example, the marker buoys and the seafloor lander apparatus can be deployed to respective locations (e.g., positions) within the same study area environment on the seafloor, and the seafloor lander apparatus may subsequently determine range and bearing (e.g., heading, direction, angular, etc.) information from the seafloor lander apparatus to each respective marker buoy of the plurality of marker buoys.

Based on the relative positioning information between the marker buoys and the seafloor lander apparatus, the seafloor lander apparatus can triangulate its own location on the seafloor within the study area environment, based on georeferencing from the known coordinates or locations of each respective one of the marker buoys. Using the georeferenced location of the seafloor lander apparatus and/or the relative positioning measurements between the seafloor lander apparatus and the marker buoys, the seafloor lander can be configured to accurately determine a distance and heading (e.g., bearing)

By strategically placing marker buoys within the scan area and detecting their positions in the subsequently obtained sonar data, the seafloor lander can determine its own location and orientation relative to the buoys. Accordingly, the systems and techniques can use the georeferencing information (e.g., determined based on the plurality of nearby marker buoys) to identify and report the detected leak locations in absolute coordinates (e.g., using the same georeferencing system, coordinates, information, etc. used to locate the seafloor lander).

In some embodiments, the seafloor lander apparatus can include a power management system and a communication system (e.g., communication module, etc.) that can be used for leakage event notification to the surface, to a satellite overhead, etc. For example, the communication system can be used to transmit leak detection alerts and associated information and/or sensor data to a surface operator or other entity associated with the seafloor lander apparatus and/or the seafloor area being monitored.

As will be described in greater depth below, the power management system can be used to monitor and control the use of stored power (e.g., from onboard batteries or generators included in the seafloor lander apparatus, etc.) to enable long-term deployment and operation of the seafloor lander, without requiring intervention or replenishment of the seafloor lander. The communication module can utilize various techniques, such as acoustic modems, tethered buoys, and/or releasable buoys, to transmit data indicative of detected leakage events to the surface or shore-based facilities.

The acoustic sensor (e.g., a sonar transceiver) can be mounted on a rotating mechanism provided by the seafloor lander, such as a horizontal panning table or arm, that allows the acoustic sensor to perform periodic sweeping scans over a full 360-degree range or field of view (or a subset thereof) to scan a pre-defined or configured area of interest for one or more leaks, anomalies, changes, etc. The sonar data collected during each scan can be processed in-situ (e.g., locally) by an onboard computing system or analysis engine of the seafloor lander apparatus, to detect and/or quantify leaks and leakage events that are sensed by the seafloor lander.

In one illustrative example, the onboard computing system or analysis engine of the seafloor lander can include or otherwise utilize one or more trained machine learning (ML) and/or artificial intelligence (AI) models, networks, algorithms, etc., to perform the leak detection based on the periodic sonar data and/or the periodic chemical measurement sensor data of the water column surrounding the seafloor lander. For example, the one or more ML or AI models can be included in an ML-based and/or AI-based (e.g., ML/AI-based) leak detection engine implemented by one or more onboard processors of the seafloor lander apparatus. The in-situ leak detection and analysis of the obtained sensor data can be performed without communications between the deployed seafloor lander apparatus and a remote computing device, surface vessel, etc.

In some aspects, the systems and techniques described herein for in-situ leak detection analysis and monitoring by the seafloor lander can be performed automatically, without human intervention, review, or input. Conventional and existing approaches to leak detection require a human in the loop to perform the review and analysis of the sensor survey data (e.g., sonar data, acoustic data, chemical measurement data, etc.) to thereby identify the presence of any gas leaks, seeps, or other anomalies represented within the sensor data. The systems and techniques described herein can remove the need for human in the loop review and analysis of the obtained sensor data, based on using the onboard ML/AI engine to perform automated and in-situ leak detection based on analyzing the sonar sensor data, acoustic sensor data, and/or chemical measurement sensor data obtained by respective sensors associated with or implemented by the seafloor lander apparatus.

For example, conventional methods often rely on manual interpretation of sonar imagery by trained experts, which is time-consuming and prone to human error. This human in the loop configuration can additionally introduce undesirable latency or delay to the leak detection, based on the delay between the sonar survey data being first obtained and then later being analyzed by the human expert. In one illustrative example, the presently disclosed seafloor lander can utilize AI and ML techniques, and various AI and ML model architectures, such that the system can learn to recognize patterns and features indicative of gas bubbles or plumes in the sonar data. For example, a convolutional neural network (CNN) can be trained on a dataset of labeled sonar images containing known gas seeps, allowing the CNN to learn to classify new sonar observations as either containing leaks or not. Similarly, unsupervised machine learning techniques such as clustering algorithms can be used to identify anomalous regions in the sonar data that deviate from the background environment, wherein the identified anomalous regions can drive subsequent detection and characterization (e.g., quantification) of an underwater leakage event.

As will be described in greater depth below, in addition to performing leak detection based on sonar and/or chemical measurement sensor data, the AI and ML models implemented by an analytics engine of the presently disclosed seafloor lander apparatus can be extended to quantify the extent and evolution (e.g., change(s)) observed for previously detected leaks over time. For example, by tracking the size, shape, and intensity of leak-related features in the sonar data across multiple scans, the systems and techniques can estimate the rate and volume of gas being released, information which can be used to better assess the severity of the leak and to guide remediation efforts.

Various aspects of the present disclosure will be described below with respect to the figures.

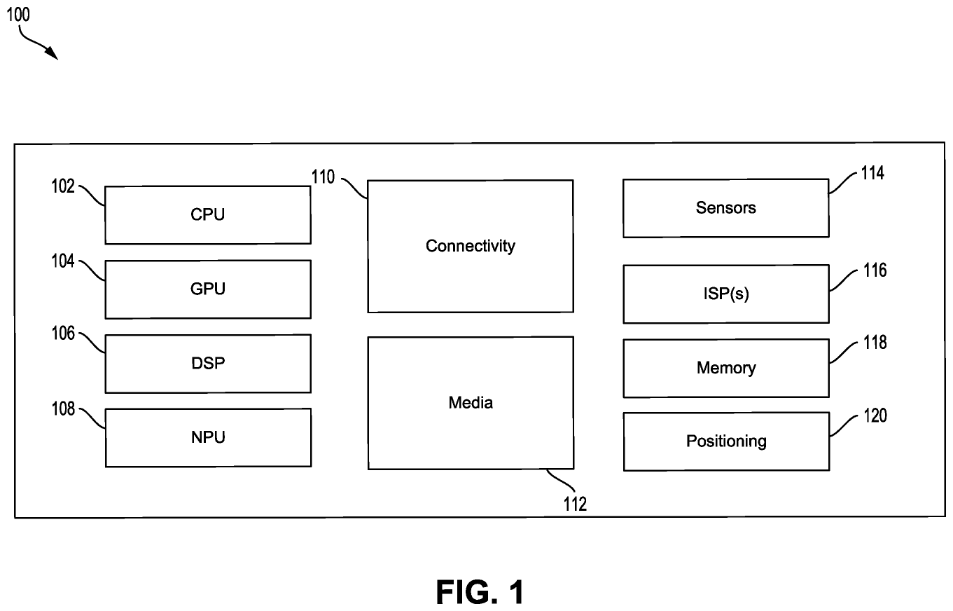

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

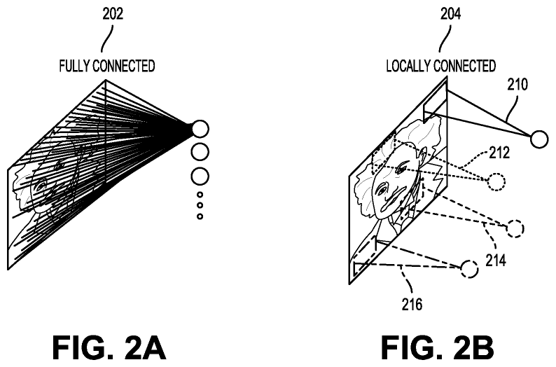

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As mentioned previously, systems and techniques are described herein for in-situ sensing, detection, and/or monitoring of leakage events on the seafloor and/or within a marine environment. In one illustrative example, disclosed is a seafloor lander-based system is that can be deployed and used to provide in-situ monitoring and detection of underwater leaks, over extended periods of time (e.g., extended deployments) without the need for replenishment or external intervention to the deployed seafloor lander system.

In some aspects the leakage detection and monitoring provided by the disclosed seafloor lander system can be used for monitoring offshore oil and gas pipelines, subsea infrastructure, and/or geological carbon storage sites (among various others) for leakage or seepage of one or more substances of interest. The substances of interest may be fluids, gases, or both. For example, the seafloor lander system can be deployed to monitor a subsea wellhead or pipeline for leakage of hydrocarbons. In another example, the seafloor lander system can be deployed to monitor a subsea reservoir or geological formation (e.g., such as a reservoir or formation used for a carbon capture and storage (CCS) project, etc.) for leakage or seepage of bubbles of carbon dioxide (CO₂), methane, or other gases that are escaping and entering the water column/surrounding marine environment within which the seafloor lander is deployed.

In some examples, leaks and seeps may both be considered types of unintended or unintentional releases of hydrocarbons or other fluids/gases. In some cases, leaks may refer to releases that are associated with structural failures (e.g., cracks, corrosion, damage, material defects, external forces, etc.) of pipelines, wellheads, and other subsea infrastructure, and seeps may refer to natural occurrences where hydrocarbons or other fluids/gases escape from the seabed or a geological formation due to geological processes. In some examples, seeps may generally, but not necessarily, be slower and more gradual than leaks. In at least some examples, the terms “leak(s)” and “seep(s)” (and corresponding terms such as “leakage” and “seepage”, etc.) may be used interchangeably to refer to a fluid or gas that escapes or is otherwise released unintentionally from containment within a manmade or natural structure.

Monitoring a marine environment for indications of CO₂ or other leakages or to can be challenging task for several reasons. Firstly, the marine environment is highly inhomogeneous and subject to significant spatial and temporal variability, making it difficult to differentiate between natural processes and potential leakage. In some cases, direct indications of leakage may include CO₂ bubbles emitted from the seabed, and/or locally elevated levels of dissolved CO₂ in the water column. Features on the seabed, such as pockmarks, bacterial mats and local depression or upheaval, may also indicate fluid flow. However, naturally occurring bubble seepage, fluctuations in seawater CO₂ levels, and the presence of fluid flow related features on the seabed are all common in the marine environment, and their presence is sparsely mapped.

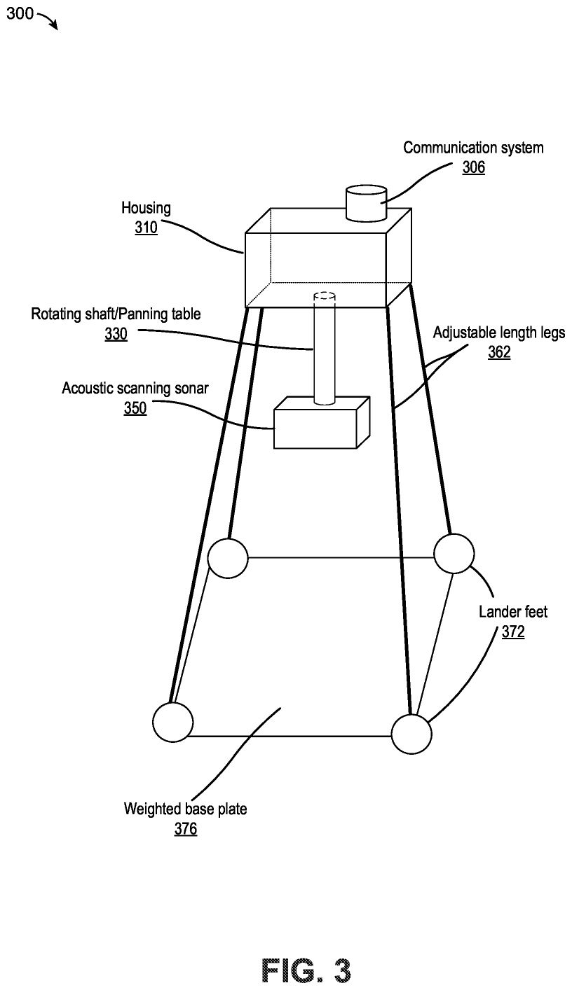

FIG. 3 is a diagram illustrating an example of a seafloor lander apparatus 300 that can be used to perform automatic detection, monitoring, and/or reporting for one or more leaks or leakage events detected on or near the seafloor surface (e.g., the seafloor surface upon which the seafloor lander apparatus 300 is deployed). As used herein, the terms seafloor and seabed may be used interchangeably.

The following description makes reference to an illustrative example in which the seafloor lander apparatus 300 is used to detect leaks (e.g., CO₂, methane, and/or various other gaseous elements or compounds) from a reservoir or geological formation located beneath the seafloor, where the leaks are detected and monitored as the leaks become visible at the seafloor. However, it is appreciated that this example is provided for purposes of illustration and is not intended to be construed as limiting, and that the presently disclosed systems and techniques can additionally, or alternatively, be used to detect and/or monitor leaks of various gases, hydrocarbons, etc., other than the example of CO₂. The presently disclosed systems and techniques can additionally, or alternatively, be used to detect and/or monitor leaks from various man-made or natural structures or formations other than the example of a carbon capture reservoir/geological formation.

In some embodiments, the seafloor lander apparatus 300 can include a housing 310 that is coupled to a plurality of adjustable-length legs 362, where the adjustable-length legs 362 are configured to support the housing 310 and/or the seafloor lander apparatus 300 when deployed on the seafloor surface. For example, the housing 310 is depicted in FIG. 3 as being coupled to four adjustable-length legs 362, although a greater or lesser number of legs 362 may also be utilized, in a same, similar, or different geometric configuration or arrangement about the housing 310.

The adjustable-length legs 362 can extend from the bottom of the housing 310 towards the seafloor surface. Each adjustable length-leg 362 may terminate in a respective lander foot 372, which may in some embodiments, be provided as an optionally weighted lander foot element 372 (e.g., to improve the stability or anchoring of the lander apparatus 300 on the seafloor surface, to prevent movement or disruptions from subsea currents, etc.). It is noted that the lander feet 372 are illustrated as circular elements in FIG. 3 for purposes of clarity of explanation, and that the lander feet 372 may be provided using various other shapes, geometries, etc., without departing from the scope of the present disclosure. For example, the lander feet 372 may be configured as spherical masses attached to or integrally formed with the distal ends of the adjustable-length legs 372, may be configured as substantially flat or planar masses having a rectangular or circular shape, etc.

In some embodiments, the lander feet 372 may optionally be coupled to an optional weighted base plate 376, where the optional weighted base plate 376 rests directly upon the seafloor surface. In some aspects, the optional weighted base plate 376 may have a footprint (e.g., area) that is greater than the footprint or area of the housing 310. In some examples, the optional weighted baseplate 376 may have a footprint that is approximately equal to the footprint of the housing 310, or may have a footprint that is smaller than the footprint of the housing 310. As noted above, the weighted lander feet 372 and/or the weighted base plate 376 can stabilize and keep stationary the seafloor lander apparatus 300 when deployed to the seafloor surface.

In some embodiments, the seafloor lander apparatus 300 can perform level compensation based on increasing and/or decreasing the respective lengths of the adjustable-length legs 362. For example, the seafloor lander apparatus 300 can perform level compensation to adjust for the bottom slope of the seafloor surface upon which the lander feet 372 rest (or upon which the optional weighted base plate 376 rests, when included in the seafloor lander apparatus 300). The level compensation, and corresponding adjustments to the lengths of the adjustable-length legs 362, can be configured and implemented such that the direction of gravity is substantially orthogonal to the housing 310 of the seafloor lander apparatus 300 when in the leveled position (e.g., the direction of gravity can be substantially orthogonal to the bottom and/or top surfaces of the housing 310, after the automatic level compensation of the seafloor lander apparatus 300).

The adjustable-length legs 362 may be independently adjustable to increase or decrease in length, may be adjustable in pairs or groups of two or more, etc. The adjustable-length legs 362 and/or an automatic slope or level compensation functionality of the seafloor lander apparatus 300 can be configured or controlled by one or more onboard systems or sub-systems of the seafloor lander apparatus 300. The onboard control systems, sub-systems, etc., can be provided within the housing 310.

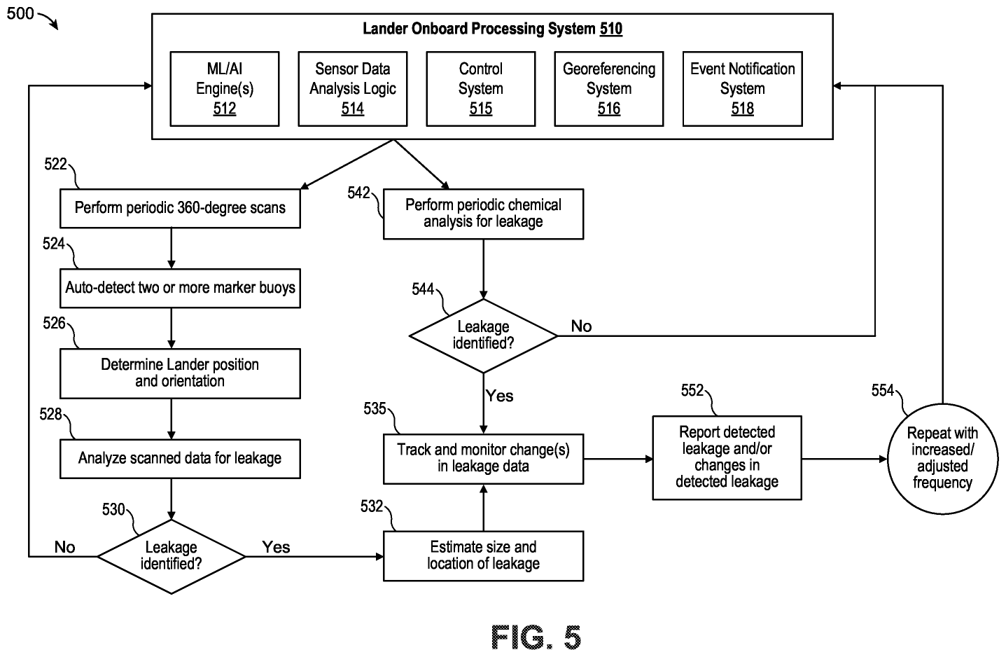

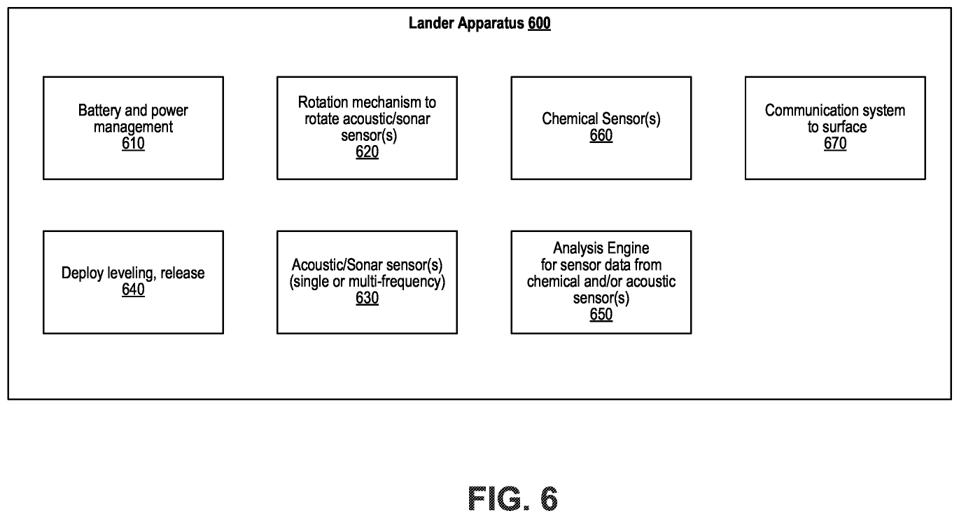

In one illustrative example, the adjustable-length legs 362 and/or an automatic slope or level compensation functionality of the seafloor lander apparatus 300 can be configured or controlled by the deploy leveling and release module 640 included in the seafloor lander apparatus 600 of FIG. 6, which can be the same as or similar to the seafloor lander apparatus 300 of FIG. 3. In another illustrative example, the adjustable-length legs 362 and/or an automatic slope or level compensation functionality of the seafloor lander apparatus 300 of FIG. 3 can be configured or controlled by the control system 514 included in the lander onboard processing system 510 of FIG. 5, which may be the same as or similar to a lander onboard processing system provided within the housing 310 of the seafloor lander apparatus 300 of FIG. 3.

The housing 310 can be design to contain (e.g., within a semi-enclosed or fully enclosed interior volume of the housing 310), various lander electronics, motors, battery or power storage systems, control systems, processing systems, sensor and data acquisition systems, control systems, etc. In some aspects, the housing 310 can be a fully enclosed housing that contains the various lander electronics, sensors, and other components within a watertight or waterproof volume. In some aspects, some (or all) of the lander electronics, sensors, and/or other components may be partially or fully exposed to the water column or marine environment within which the lander 300 is deployed. In some cases, the housing 310 may be implemented as a semi-enclosed volume, or as a non-enclosed frame to which the lander electronics, sensors, components, etc. are mounted (optionally with one or more individual components and/or subsets of the plurality of lander components coupled to the frame within a waterproofed or environmentally sealed housing of their own, etc.).

In some embodiments, the lander onboard processing system 510 of FIG. 5 can be included in the seafloor lander apparatus 300 of FIG. 3, and may be located within the housing 310. For instance, the housing 310 can include the ML/AI engine(s) 512, the sensor data analysis logic 514, the control system(s) 515, the georeferencing system(s) 516, the event notification system(s) 518, etc.

In some aspects, the seafloor lander apparatus 300 of FIG. 3 can include (e.g., within the housing 310) one or more of the components shown in the seafloor lander apparatus 600 of FIG. 6. For example, the housing 310 of FIG. 3 can include a battery and power management system that is the same as or similar to the battery and power management system 610 of FIG. 6; can include a rotation mechanism that is the same as or similar to the rotation mechanism 620 of FIG. 6; can include chemical sensors and/or chemical measurement systems that are the same as or similar to the chemical sensors 660 of FIG. 6; can include a communication system that is the same as or similar to the communication system 670 of FIG. 6; can include a deployment leveling and release system that is the same as or similar to the deployment leveling and release system 640 of FIG. 6; can include one or more acoustic and/or sonar sensors that are the same as or similar to the one or more acoustic and/or sonar sensors 630 of FIG. 6; can include one or more analysis engines that are the same as or similar to the sensor data analysis engines 650 of FIG. 6; etc.

In one illustrative example, the housing 310 of the seafloor lander apparatus 300 of FIG. 3 includes (e.g., contains) a battery system that is configured to provide long-term electrical power to the seafloor lander apparatus 300, for example during extended deployment periods on the seafloor surface. In some embodiments, the presently disclosed seafloor lander can be designed for extended deployments of one year or longer, where the seafloor lander performs periodic measurements to monitor and detect for leaks and operates continuously for the extended deployment duration without requiring service or replenishment from a surface vessel, ROV, AUV, etc. In some aspects, the seafloor lander can be configured for multi-year deployments (e.g., 2 years, 3 years, . . . , etc.), where the seafloor lander performs periodic measurements to monitor and detect for leaks and operates continuously for the extended deployment duration without requiring service or replenishment from a surface vessel, ROV, AUV, etc.

In some cases, the battery system included within the housing 310 can be adjusted to have a corresponding capacity based on an anticipated deployment length or service interval for the seafloor lander apparatus 300. For example, the battery system of a seafloor lander configured for a 3-year deployment duration can have a larger capacity for the storage of electrical energy as compared to the battery system of a seafloor lander configured for a 1-year deployment duration. In some embodiments, the battery system implementation and/or electrical storage capacity may be determined based on a combination of the expected deployment duration of the seafloor lander, as well as a sensor payload package or estimated electrical power draw/load of the onboard components of the seafloor lander apparatus 300.

The battery system capacity may be based still further on a configured or estimated sensor scanning or surveying periodicity (e.g., frequency of performing and/or time interval between the periodic sensor scans/surveys performed by the seafloor lander apparatus 300 to monitor for and detect leaks at the seafloor surface, etc.). For example, doubling the number of sensor scans performed per day may correspond to approximately doubling the electrical power consumption of the lander, and approximately halving the time to depletion of the battery storage onboard the lander 300.

The seafloor lander apparatus 300 can further include one or more acoustic scanning sonars and/or various other acoustic sensors, sonar sensors, etc., configured for use in the leak detection and monitoring performed by the seafloor lander apparatus 300. For example, the seafloor lander apparatus 300 can include an acoustic scanning sonar 350 that extends from the housing 310 on a rotating shaft or panning table 330 that is configured to controllably rotate the acoustic scanning sonar 350 through a 360-degree field of view in the horizontal plane. In some examples, the acoustic scanning sonar 350 can be implemented as a scanning sonar configured to emit sound waves in a single plane (e.g., a non-volumetric scanning sonar, etc.). In other examples, the acoustic scanning sonar 350 can be implemented as a volumetric scanning sonar configured to capture 3D volumetric data based on emitting sound waves or pulses in multiple directions, either simultaneously or successively.

In some cases, leak detection and monitoring can be performed using active acoustic sensors such as sonars and/or echosounders (e.g., MBES, SBES, sidescan sonar, SAS, scanning sonar, volumetric scanning sonar, etc.) that operate based on transmitting sound and analyzing the reflected signal to detect the presence of bubbles within the water column or sediments on the seafloor. Active acoustic sensors, such as the acoustic scanning sonar 350, can be used to perform leak detection at distances of tens to hundreds of meters (e.g., for moderate bubble seepage), as gas-filled bubbles in water provide strong acoustic targets for reflection of the transmitted acoustic or sonar signal. In some aspects, the detection range of an active acoustic sonar (e.g., such as the acoustic scanning sonar 350) may depend at least in part on properties or characteristics of the leak, such as the leak rate/flow rate and bubble size distribution, in addition to a further dependence on the particular type and respective characteristics of the acoustic sensor/sonar that is used for the leak detection.

In some aspects, the acoustic scanning sonar 350 can be implemented using a single- or split-beam echo sounder (SBES), a multi-beam echosounder (MBES), a sidescan sonar (SSS), a synthetic aperture sonar (SAS), a scanning sonar, a volumetric scanning sonar, etc. In general, it is contemplated herein that the acoustic scanning sonar 350 may be a single-beam/single-frequency sonar system, or may be a multi-beam/multi-frequency sonar system. For example, in embodiments where the acoustic scanning sonar 350 is implemented as a single frequency sonar system, the single frequency can correspond to a sonar beam having a horizontal direction beam component and a vertical direction beam component (e.g., a three-dimensional sonar beam having a height in the vertical direction and a width, spread, angular extent, etc., in the horizontal direction). In one illustrative example, the single frequency can correspond to a sonar beam that is relatively narrow in the horizontal direction and relatively tall in the vertical direction. For example, the vertical extent or vertical direction component of the sonar beam can be greater than (e.g., larger than) the horizontal extent or horizontal direction component of the sonar beam. The horizontal direction can be the direction substantially parallel to the seafloor and/or orthogonal to the direction of gravity. Based on sweeping (e.g., rotating) the single sonar beam through 360° (or other configured angular range), the relatively narrow horizontal sonar beam component can obtain measurements of the full horizontal measurement plane. For example, given a single sonar beam with a relatively narrow horizontal component with an angular width of approximately 1°, the full horizontal measurement plane can be measured using 360 measurement positions as the single sonar beam is swept or rotated through the 360° of the horizontal measurement plane. In embodiments where the acoustic scanning sonar 350 is implemented as a single-frequency sonar system and/or in embodiments where the acoustic scanning sonar 350 is implemented as a multi-frequency sonar system, a relatively wide beam can be supported in the vertical dimension (e.g., top to bottom in the example of FIG. 3) and a relatively narrow beam can be supported in the horizontal dimension (e.g., left to right/side to side in the example of FIG. 3).

In some examples, the acoustic scanning sonar 350 can be coupled to the housing 310, such that the acoustic scanning sonar 350 extends away from the bottom of the housing 310 (e.g., the acoustic scanning sonar 350 can be provided below the housing 310, in a bottom-mounted configuration). In such examples, the acoustic scanning sonar 350 can be designed to minimize the obstruction in the sonar scans from the lander legs 362 also extending from the bottom of the housing 310. In some cases, processing can be performed to remove artifacts or reflects from the sonar scan data that correspond to the lander legs 362.

In some embodiments, the acoustic scanning sonar 350 may be coupled to the housing 310, such that the acoustic scanning sonar 350 extends from the top of the housing 310 (e.g., the acoustic scanning sonar 350 can be provided above the housing 310, in a top-mounted configuration). In either the top or bottom-mounted configurations of the acoustic scanning sonar 350 relative to the housing 310, the acoustic scanning sonar 350 can be coupled to the housing 310 via a rotating shaft/panning table 330 and/or a rotatable or otherwise movable arm. In some cases, the top-mounted configuration where the acoustic scanning sonar 350 extends from the top or upper surface of the housing 310 can provide an unobstructed 360-degree view for scanning by the acoustic scanning sonar 350, in the horizontal dimension, the vertical dimension, or both (e.g., various combinations of horizontal and vertical beams and/or beam widths, etc.).

In some cases, a top-mounted acoustic scanning sonar 350 can be stowable during deployment and/or recovery of the seafloor lander apparatus 300, for example to prevent damage to the acoustic scanning sonar 350 from rigging gear used and attached to the seafloor lander apparatus 300 during deployment and recovery operations. For example, a top-mounted acoustic scanning sonar 350 can be stowable based on the rotating shaft/panning table 330 retracting partially or wholly into the interior volume of the housing 310, such that in the stowed (e.g., retracted) position the acoustic scanning sonar 350 is brought closer to the housing 310 and in the deployed (e.g., extended) position the acoustic scanning sonar 350 is moved farther away from the housing 310. In some cases, the acoustic scanning sonar 350 can be mounted to the housing 310 in a top-mounted configuration, without using a retractable arm or retractable rotating shaft/panning table 330 (e.g., the acoustic scanning sonar 350 may be top-mounted at a fixed position relative to the housing 310, where the same fixed position is used during deployment operations, during use of lander and sonar on the seafloor, and during recovery operations).

In some embodiments, the acoustic scanning sonar 350 can be coupled to the housing 310 by a retractable arm that allows the acoustic scanning sonar 350 to be raised and lowered (e.g., extended and retracted, respectively) relative to the housing 310, to minimize obstruction from the lander during scanning operations and to minimize the risk of damage during deployment and recovery operations of the lander 300. In some cases, the rotating shaft/panning table 330 can be coupled to a rotation mechanism within the housing 310, configured to provide 360-degree rotation of the acoustic scanning sonar 350. The rotating shaft/panning table 330 may additionally be coupled to a linear actuator or other extension and retraction mechanism within the housing 310, configured to provide vertical extension and retraction of the acoustic scanning sonar 350 as described above. For example, a linear actuator of approximately 6-12 inches actuation distance can be used to extend and retract the acoustic scanning sonar 350, although it is noted that various other actuation distances may also be utilized without departing from the scope of the present disclosure.

In the bottom-mounted configuration (e.g., shown in FIG. 3) or the top-mounted configuration (e.g., described above) of the acoustic scanning sonar 350 relative to the housing 310, the rotating shaft/panning table 330 can be used to rotate the acoustic scanning sonar 350 through a 360-degree scanning range in order to perform sonar surveying operations for leak detection and monitoring. For example, the acoustic scanning sonar 350 can be implemented using various types and/or configurations of sonar transceiver and/or other acoustic transceivers, as noted previously. The rotating shaft/panning table 330 can be rotated (e.g., by a corresponding rotation mechanism, motor, etc., within the housing 310) or swept over the full 360-degree rotation range, or can be rotated over a smaller angular range that is a subset or portion of the full 360-degree rotation range. The subset or portion of the angular range that is to be swept during scanning operations of the acoustic scanning sonar 350 can be configured by a user, can be pre-determined or pre-configured, etc.

The rotation or sweep rate of the acoustic scanning sonar 350 can be the same as the rotation or sweep rate of the rotating shaft/panning table 330, based on a rigid coupling between the acoustic scanning sonar 350 and the rotating shaft/panning table 330 (e.g., the sonar 350 and shaft 330 may be rotated as a single body). A rotation over the configured angular range (either the full 360-degrees or a smaller, user-defined portion thereof) can comprise a single scan or survey performed by the acoustic scanning sonar 350 for the surrounding seafloor environment within which the seafloor lander apparatus 300 is located. In some aspects, a configured or user-defined subset or portion of the full 360-degree rotation range can be referred to as a “sector of interest” for the leak detection and monitoring sonar scanning survey operations performed by the lander 300 and using the acoustic scanning sonar 350. For example, a sector of interest can be automatically defined (e.g., by onboard processing logic and/or one or more ML or AI engines of the seafloor lander apparatus 300, described in greater detail below) based on a low-confidence detection of a potential leak or gas bubble, based on a detection of an anomaly or unknown object, etc., that is located within the later-defined sector of interest. The angular range over which the sector of interest is defined or configured can then be re-scanned one or more times and further sonar scan data collected and analyzed to thereby refine the low-confidence leak detection and determine either a positive or negative detection of a leak and/or to resolve the detection of the anomaly or unknown object, within the sector of interest. In some cases, the rescanning operations or additional scans performed by sweeping the acoustic scanning sonar 350 over the sector of interest (e.g., by configuring the rotation mechanism of the rotating shaft/panning table 330 to rotate through or sweep over only the sector of interest) can be performed with different sonar acquisition parameters than the full 360-degree scan from which the sector of interest was defined or determined. For example, to resolve a low-confidence leak detection or anomaly/unknown object, the sector of interest can be swept and scanned by the sonar 350 using a higher transmit power, using a slower rotation speed (e.g., to increased acquisition resolution), using a different sonar beam shape or configuration, etc.

More generally, it is contemplated that the rate of rotation of the rotating shaft/panning table 330 and the attached acoustic scanning sonar 350 can be configured based on the scanning characteristics of the sonar 350, the desired survey being performed, or both. As noted previously, the acoustic scanning sonar 350 can be provided as a single or multifrequency sonar system, and may support a wide beam in the vertical dimension and a narrow beam in the horizontal dimension. In some embodiments, the acoustic scanning sonar 350 may be implemented using a three-dimensional acoustic camera, or other sensor system that can be used to measure range and bearing to targets (e.g., gas bubbles and/or other indications of a leak) visible within an imaged/surveyed area.

For example, the rate of rotation can correspond to an angular velocity at the transceiver of the acoustic scanning sonar 350 that allows the sonar 350 to scan the horizon for any indications of leaks. The sonar 350 can be used to obtain two-dimensional (2D) sonar data and/or three-dimensional (3D) sonar data. For example, 2D sonar data can correspond to measurements along the horizontal plane or dimension, and 3D sonar data can add an additional dimension to the sonar data corresponding to the vertical plane or dimension. In one illustrative example, the acoustic scanning sonar 350 can be configured to scan the seafloor (e.g., seabed) environment upon which the lander apparatus 300 is deployed and the surrounding area thereof. For example, the acoustic scanning sonar 350 can obtain sonar scan data (e.g., sonar sensor data) of the seafloor and the water volume (e.g., water column) immediately above the seafloor. In some cases, 2D sonar data can include a relatively small portion of vertical information corresponding to scanning a relatively small height of the water volume above and/or below the 2D scanning plane. In some examples, 3D sonar data can include a relatively large portion of vertical information corresponding to scanning a relatively large height of the water volume or water column, in addition to scanning the seafloor surface.

In some embodiments, the rotating shaft/panning table 330 and/or the corresponding rotation mechanism provided within the housing 310 can include an encoder that can be used to determine a relative bearing of the acoustic scanning sonar 350 head (e.g., the transceiver head of the acoustic scanning sonar 350, where the bearing of the transceiver head is the bearing along which the sonar acoustic signal is transmitted and along which reflections are received as the sonar scan data). The relative bearing or rotational position information determined from the encoder can be referred to as the sonar head bearing and/or the panning table bearing (e.g., table bearing), etc.

In some aspects, the seafloor lander apparatus 300 can include a recovery system that can be used to recover the seafloor lander apparatus 300 from the seafloor environment (e.g., to a surface vessel, an ROV, an AUV, etc.). For example, the recovery system may be used to recover the seafloor lander apparatus 300 at the end of the desired deployment of the seafloor lander apparatus 300, to perform replenishment operations for the seafloor lander apparatus 300, to perform maintenance or repair operations for the seafloor lander apparatus 300 (although it is noted that the seafloor lander apparatus 300 is designed for prolonged deployment with minimal to no intervention), etc.

In one illustrative example, the recovery system of the seafloor lander apparatus 300 can be based on one or more acoustic release techniques, wherein the recovery of the seafloor lander apparatus 300 is triggered remotely by an acoustic command signal to the acoustic release-based recovery system included in the seafloor lander apparatus 300. For example, the seafloor lander apparatus 300 may include one or more hydrophones that can be used to detect underwater sounds, such as acoustic communications (e.g., including the acoustic command signal to release and recover the seafloor lander apparatus 300). The seafloor lander apparatus 300 can additionally include one or more actuators, hooks, or other controllable mechanisms that can couple and decouple the seafloor lander apparatus 300 from one or more weights anchoring the seafloor lander apparatus 300 to the seafloor.

For instance, hooks or actuators can be used to couple the legs 362 to the optionally weighted lander feet 372, such that the acoustic release command signal causes the hooks or actuators to open and decouple the seafloor lander apparatus from the weighted lander feet 372. When decoupled from the weighted lander feet 372, the buoyancy of the seafloor lander apparatus 300 (e.g., the housing 310, and/or various other components) can be such that the seafloor lander apparatus 300 rises or floats to the sea surface (or some other height within the water column, above the seafloor) where the seafloor lander apparatus 300 may then be recovered.

In another example, hooks or actuators can be used to couple the lander feet 372 to the optional weighted base plate, such that while coupled, the weighted base plate 376 anchors the seafloor lander apparatus 300 to the seafloor. Based on detecting or receiving the remotely triggered and transmitted acoustic release command signal, the hooks or actuators can be opened and the seafloor lander apparatus 300 decoupled from the weighted base plate 376, allowing the seafloor lander apparatus 300 to rise upwards (e.g., away from the seafloor surface) for recovery.

In some aspects, the seafloor lander apparatus 300 can include a recovery system that includes a releasable anchor weight (e.g., releasable in response to receiving the remotely triggered acoustic release command signal) that is different and separate from the optional weighted lander feet 372 and/or the optional weighted base plate 376.

In some embodiments, the recovery system of the seafloor lander apparatus 300 may additionally, or alternatively, comprise a releasable buoy and line system that can be used by a surface vessel to recover the lander 300 and its sensors. For example, the releasable buoy can be attached to the seafloor lander apparatus 300 while the lander is deployed and operating on the seafloor surface. An acoustic release mechanism (e.g., the same as or similar to that described above) can be used to release the releasable buoy and line in response to the seafloor lander 300 receiving or otherwise detecting the appropriate acoustic release command signal. Once released, the buoy may float to the ocean surface while trailing a line or tether (e.g., a line or tether coupled at its first distal end to the buoy, and coupled at its second distal end to the seafloor lander apparatus 300). A surface vessel can recover the released buoy, and may thereby recover the seafloor lander apparatus 300 from the seafloor surface by winching or reeling in the line that is trailed from the buoy and attached to the seafloor lander apparatus 300.

The seafloor lander apparatus 300 can further include one or more communication systems 306, which can be used to communicate information indicative of leak detection(s), leak change information, leak monitoring information, raw or processed sonar data, etc., from the seafloor lander apparatus 300 to the surface. In some embodiments, the communication system 306 can include or otherwise be the same as the one or more hydrophones used by the lander recovery system to receive the acoustic release command signal that triggers the acoustic release and recovery described above.

In some cases, the communication system 306 can include multiple communication modalities, transceivers, systems, etc. For example, the communication system 306 can include the one or more hydrophones as noted above, can include one or more acoustic modems configured to transmit data acoustically to the surface of the water (and/or to receive data acoustically from the surface of the water), etc. The one or more acoustic modems on the seafloor lander apparatus 300 (e.g., included within the communication system 306) can provide communications from the seafloor lander apparatus 300 to a corresponding acoustic receiver at the surface, for example mounted on an unmanned surface vessel (USV), a manned surface vessel that visits the lander 300 deployment location periodically to retrieve or receive communications, etc.

In some embodiments, the communication system 306 can include one or more acoustic modems configured to communicate to a surface buoy, where the surface buoy acts as a relay to a satellite communication system or other wireless radio frequency (RF) communication systems. For example, the seafloor lander 300 can use the one or more acoustic modems to transmit measurement or monitoring results, as well as leakage alarms or leak detection and/or change information, to the surface relay buoy. A corresponding acoustic receiver on the surface relay buoy can be used to receive the communications from the seafloor lander 300 and its communication system 306. The surface relay buoy can further include one or more wireless RF communications systems and/or transceivers configured to relay the communications form the seafloor lander 300 onward to a control center, operations center, or other monitors on shore, etc., using a satellite network, wireless RF network, etc.

In another example, the communication system 306 can comprise or include a tethered buoy system, where the tether buoy floats at the surface of the ocean and is connected (e.g., tethered) to the seafloor lander apparatus 300 deployed on the seafloor surface below. Via the tether to the surface buoy, the seafloor lander apparatus 300 can transmit and receive communications, based on the tethered surface buoy acting as a relay to a satellite communications network and/or other wireless RF communications network. In another example, the communication system 306 can include or comprise a releasable buoy system that operates similarly to the tether buoy system once released (e.g., the tethered buoy is initially stored on or within the seafloor lander 300, and is released from the seafloor surface at a time subsequent to the initial deployment of the seafloor lander 300). In some aspects, the tethered buoy used for communications (and/or a releasable buoy that functions the same as the tethered buoy after being released) can also be utilized as a recovery system of the seafloor lander apparatus 300. For example, the releasable buoy system can include a releasable buoy that acts as both the tethered communications buoy described above and the releasable recovery buoy described above. In some examples, the seafloor lander apparatus 300 may include separate releasable and/or tethered buoys for communication, and a releasable buoy for recovery. For example, one or more releasable buoys may be mounted to the seafloor lander apparatus 300 and used for one or more of communications, recovery, or both.

In some embodiments, the seafloor lander apparatus 300 may optionally include one or more chemical measurement sensors, in addition to the acoustic scanning sonar 350. For example, the one or more chemical measurement sensors can be used to measure one or more gases embedded in the water column surrounding the seafloor lander apparatus 300. The chemical measurement sensor(s) can be mounted to the rotating shaft/panning table 330, but do not necessarily require rotation in order to operate. For example, the chemical measurement sensor(s) may instead be mounted in a fixed position on the housing 310, as the chemical measurement sensors can operate in either configuration if given open access to the water around the lander 300. In some aspects, the chemical measurement sensor(s) can be configured to perform monitoring and/or detection of only the chemicals or substances that are of interest (e.g., that are the target for) the leak detection and monitoring performed by the seafloor lander apparatus 300. For example, the chemical measurement sensors and/or the seafloor lander apparatus 300 as a whole may be configured to detect and monitor gases, such as H₂ leaks, CO leaks, CO₂ leaks, H₂S leaks, NH₃ leaks, NOₓ leaks, methane leaks, or other hydrocarbon leaks including but not limited to ethane, propane, butane, hexane, ethylene and/or benzene, etc. In some cases, the chemical measurement sensors may obtain chemical measurements for a wider range of chemicals or substances beyond just those that are identified as the targets for leak detection and monitoring.

In some examples, where the seafloor lander apparatus 300 includes one or more chemical measurement sensors, the seafloor lander apparatus 300 may be deployed to a seafloor location that is down-current of a most likely leak location or specific subsea target of the monitoring (e.g., a wellhead, pipeline, etc.). Based on the down-current location to which the seafloor lander apparatus 300 is deployed, the prevailing ocean currents can move the leaked substances from the location of the leak towards the lander apparatus 300, where the chemical measurement sensors can detect and/or quantify the presence of the leaked substance(s) within the water column. The substances detected and/or quantified by the chemical measurement sensors may include, but are not limited to, one or more of H₂, CO, CO₂, H₂S, NH₃, NOₓ, methane, or other hydrocarbon(s), etc.

The systems and techniques described herein can perform leak detection, monitoring, and/or analysis using only acoustic sonar data as input (e.g., obtained from the sweeping or rotating surveys performed by the acoustic scanning sonar 350), using only chemical measurement data as input (e.g., obtained from the one or more optional chemical measurement sensors mounted to the housing 310 with open access to the surrounding water), and/or using various combinations of both acoustic sonar data and chemical measurement data.

For example, combining acoustic sonar data and chemical measurement data can increase the confidence of a leak detection or leak change notification determined by the seafloor lander apparatus 300. For example, the acoustic scanning sonar 350 can detect one or more bubbles that are identified as leaks at a first confidence level, and the chemical measurement sensors can detect the presence of the target leaked substance within the surrounding water at the same or substantially similar time (e.g., within a 5, 10, 15, etc., time window around the detection of the bubbles by the acoustic scanning sonar 350). Based on the sonar data and the chemical measurement sensor data both being indicative of the presence of a leak, the seafloor lander apparatus 300 can determine a leak detection at a second confidence level that is higher than the first confidence level associated with leak detection by the acoustic scanning sonar 350 alone.

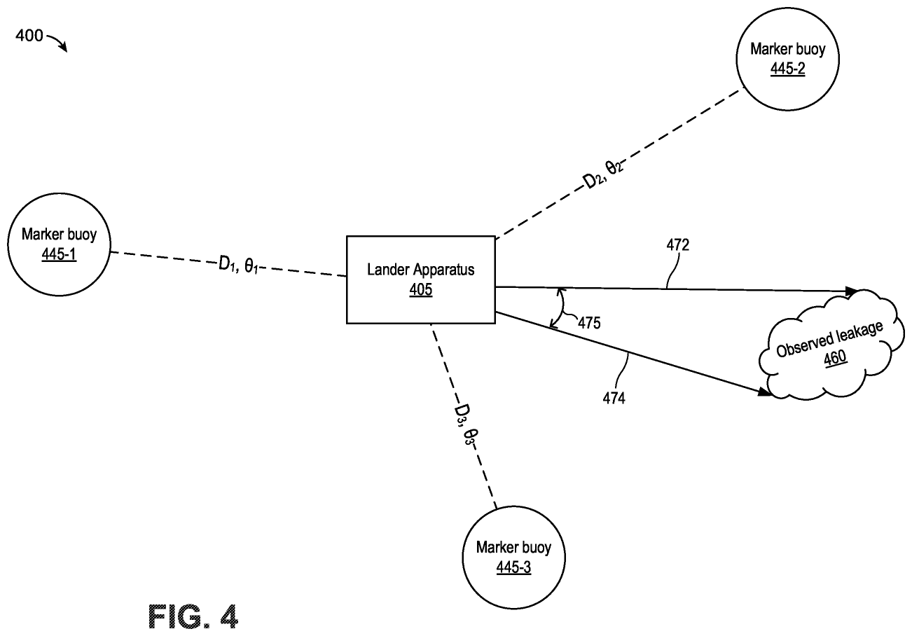

FIG. 4 is a diagram illustrating an example of a seafloor lander apparatus 405 deployed to a seafloor environment and associated with a plurality of seabed marker buoys for positioning and georeferencing of the seafloor lander apparatus. For example, the diagram of FIG. 4 presents a schematic, top-down view of the seafloor lander apparatus 405 deployed on the seafloor surface, along with a first marker buoy 445-1, a second marker buoy 445-2, and a third marker buoy 445-3. It is noted that three marker buoys are shown for purposes of example, and a greater or lesser number of marker buoys may also be utilized, and in various geometric arrangements relative to the seafloor lander apparatus 405, without departing from the scope of the present disclosure.

In some aspects, the seafloor lander apparatus 405 of FIG. 4 can be the same as or similar to the seafloor lander apparatus 300 of FIG. 3. The plurality of marker buoys 445-1, 445-2, 445-3, . . . , etc., may be collectively referred to herein as “the marker buoys 445”. The marker buoys 445 may be deployed to the seafloor surface simultaneously with the seafloor lander apparatus 405, before the seafloor lander apparatus 405, or after the seafloor lander apparatus 405. The plurality of marker buoys 445 may be deployed at the same time as one another, and/or at various different times. In general, it is contemplated that the plurality of marker buoys can be used to provide georeferenced positioning information to the seafloor lander apparatus 405, where the seafloor lander apparatus 405 uses the georeferenced positioning information associated with the marker buoys 445 to accurately determine its own location (e.g., the location of the seafloor lander apparatus 405). The leaks detected by the seafloor lander 405 using the acoustic scanning sonar rotatably mounted to the seafloor lander 405 are identified based on relative positioning with respect to the location of the seafloor lander 405. For instance, a leak detected by the acoustic sonar can be associated with a relative position comprising a range and a bearing from the lander apparatus 405. From the accurate, geo-referenced location of the lander apparatus 405 that is determined using the marker buoys 445, the lander apparatus 405 can thereby generate accurate georeferenced locations for each detected leak, based on combining the relative range and bearing to each leak with the geo-referenced location of the lander apparatus 405.

In some aspects, each marker buoy of the plurality of marker buoys 445 can be the same as or similar to one another. In some cases, the marker buoys 445-1, 445-2, 445-3 can be configured as acoustic reflectors, that provide strong reflections of the acoustic sonar signal(s) transmitted by the scanning sonar of the lander apparatus 405 (e.g., the acoustic scanning sonar 350 of FIG. 3, etc.). For example, the marker buoys 445 can each be implemented as a reflective sphere or ball mounted on a stand, frame, legs, etc., that rises to a height of approximately 1 to 1.5 meters above the seafloor surface. Other designs, configurations, and heights from the seafloor surface may also be used to implement the plurality of marker buoys 445, without departing from the scope of the present disclosure.

The plurality of marker buoys 445 can be used as reference points (e.g., reference locations) for determining the position of the lander apparatus 405 and/or the orientation of the lander apparatus 405. As used herein, the orientation, heading, or bearing of the lander apparatus 405 may be used to refer to the orientation, heading, or bearing of the sonar head/transceiver used to perform leak detection and monitoring by the lander apparatus 405 (e.g., the acoustic scanning sonar 350 of FIG. 3, etc.).

In one illustrative example, the marker buoys 445 can be deployed with recoverable beacons. For example, each marker buoy 445 can be deployed with a respective recoverable beacon attached or coupled thereto. Once deployed on the seafloor surface, each marker buoy 445 can then be accurately positioned from a surface vessel that is positioned by GPS or other satellite-based positioning systems and/or techniques. In some embodiments, the marker buoys 445 can be positioned using an ultra-short baseline (USBL) acoustic positioning technique. For example, a transceiver can be deployed from the surface vessel to communicate with the underwater beacons on each marker buoy 445. The USBL positioning technique can then calculate the position of each beacon attached to one of the marker buoys 445-1, 445-2, 445-3, etc., based on the time delay and angle of the returned acoustic signals from the beacon.

In some aspects, the marker buoys 445-1, 445-2, 445-3 can be positioned by a boxing-in technique using USBL (e.g., among various other acoustic techniques). The transceiver deployed from the surface vessel can be mounted to the hull of the surface vessel, and emits acoustic pulses that are received by the beacon attached to each marker buoy 445-1, 445-2, 445-3. The respective beacon attached to each marker buoy 445-1, 445-2, 445-3 can subsequently respond by transmitting its own acoustic signal in response to receiving the acoustic pulse(s) from the surface vessel transceiver.

The surface vessel transceiver can measure the time taken for the return signal to be received from the beacons on the marker buoys 445, as well as the angle of arrival for each respective return signal. The time delay between the emitted signal and the received return signal can be used to calculate the range (e.g., distance) from the transceiver to the beacon, and the angle of arrival (e.g., relative to the transceiver's baseline array) can be used to determine the direction to the beacon. The range and direction can be combined to determine the beacon's position relative to the surface vessel transceiver in three dimensions (e.g., latitude, longitude, and height/depth). The surface vessel transceiver position can be a GPS or other satellite-based position or coordinate.

Boxing-in can be performed by obtaining multiple USBL readings from the surface vessel transceiver to the underwater beacons at the marker buoys 445, where the multiple USBL readings are taken from different angles and positions as the surface vessel moves around in a box-shaped pattern (e.g., a box shaped pattern that encloses the plurality of beacons 445 on the seafloor, etc.). The multiple USBL readings taken during the boxing-in process can be used to refine the position accuracy for the beacons and marker buoys 445, averaging out any positional areas or other inaccuracies that may be present in any given individual USBL reading and corresponding positions calculated for the beacons/marker buoys 445 from that individual USBL reading.

In some cases, the initial positioning can be performed for both the seafloor lander apparatus 405 and each one of the plurality of marker buoys 445 (e.g., each marker buoy 445-1, 445-2, 445-3, etc.). In some cases, the initial positioning can be performed for the plurality of marker buoys 445 and not the seafloor lander apparatus 405.

In some embodiments, the beacons used for the initial positioning (e.g., USBL-based or acoustic-based boxing in from the surface vessel) of the seafloor lander 405 and/or the plurality of marker buoys 445 can comprise recoverable acoustic transceivers. For example, the beacons can be recoverable acoustic transceivers that are detachably coupled to the seafloor lander 405 and the marker buoys 445-1, 445-2, 445-3 via an acoustic release mechanism as described above. After the initial positioning has been performed, and an accurate location has been determined for each marker buoy 445-1, 445-2, 445-3 and the seafloor lander 405, acoustic release signals can be transmitted to release and recover the recoverable beacons used in the initial positioning process.

After the marker buoys 445 have been positioned and geo-referenced as described above, the seafloor lander apparatus 405 can position itself relative to the plurality of marker buoys 445-1, 445-2, 445-3 (e.g., each of which has an accurate position or location known from the USBL-based boxing in performed by the surface vessel during deployment operations).

In some cases, the plurality of marker buoys 445 can include a minimum of two marker buoys that can be used by the lander 405 to fix its location and heading. The accuracy of the lander 405 estimated location and heading can be improved (e.g., increased) with the addition of more marker buoys 445. For example, the inclusion of three or more marker buoys in the plurality of marker buoys 445 can remove the ambiguity in lander 405 location and heading that may be present when only two marker buoys 445 are used. The use of three or more marker buoys 445 can additionally provide redundancy and/or a position quality check if one or more of the marker buoys 445 is moved or displaced by external or environmental issues, factors, forces, events, etc.

For example, as the lander apparatus 405 can perform a sonar scan over the full 360-degree surveying angular range of the acoustic scanning sonar, and may detect each respective marker buoy 445-1, 445-2, 445-3, . . . , etc., of the plurality of marker buoys 445 that have been deployed and geo-referenced via the USBL-based boxing in. The reflection of the transmitted sonar signal by each marker buoy 445 can be used to calculate a distance (e.g., range) from the sonar head at the lander apparatus 405 to the reflector at the marker buoy 445. For example, the lander apparatus 405 can determine a range/distance D₁ to the first marker buoy 445-1, a range/distance D₂ to the second marker buoy 445-2, a range/distance D₃ to the third marker buoy 445-3, . . . , etc.

The angle (e.g., heading or bearing) from the lander apparatus 405 sonar head to each respective marker buoy 445-1, 445-2, 445-3 can be determined using the encoder associated with the rotation or sweeping scan of the sonar head (e.g., the encoder associated with the rotating shaft/panning table 330 and acoustic scanning sonar 350 of FIG. 3, etc.). For example, the encoder heading or angle of the sonar head at the time the respective reflection is received from each marker buoy 445-1, 445-2, 445-3, . . . , etc., of the plurality of marker buoys 445 can be used as the corresponding heading from the lander apparatus 405 sonar head to the marker buoy. For instance, the lander apparatus 405 can use the encoder to determine a heading θ₁ to the first marker buoy 445-1, a heading θ₂ to the second marker buoy 445-2, a heading θ₃ to the third marker buoy 445-3, . . . , etc.

During the sweeping (e.g., rotating, panning, etc.) survey by the acoustic scanning sonar head of the lander apparatus 405, respective relative positioning information is determined from the lander apparatus 405 to each one of the marker buoys 445. First relative positioning information D₁, θ₁ is determined from the lander apparatus 405 to the first marker buoy 445-1, second relative positioning information D₂, θ₂ is determined from the lander apparatus 405 to the second marker buoy 445-2, third relative positioning information D₃, θ₃ is determined from the lander apparatus 405 to the third marker buoy 445-3, . . . , etc.

Based on the relative positioning information to each marker buoy 445, and further based on the geo-referenced position for each marker buoy 445 that was previously determined by the surface vessel USBL-based boxing in positioning process, the lander apparatus 405 can calibrate the encoder's angular offsets and ensure precise leak localization during regular scanning or surveying operation of the rotating sonar head. For example, when a leak is detected (e.g., the observed leakage 460 of FIG. 4), the lander apparatus 405 can calculate the position of the leak using the known locations of the lander apparatus 405 and/or one or more (or all) of the marker buoys 445-1, 445-2, 445-3, . . . , etc., of the plurality of geo-referenced marker buoys 445, as well as the sonar range and encoder angular data.

In some cases, the calculated position of the detected leak 460 can be determined as a single position or location corresponding to sonar scan data obtained from a single range/distance value and a single angular value for the sonar head bearing. In some examples, the calculated position of the detected leak 460 can correspond to multiple sonar scan observations, for example over an angular range 475 defined between a first sonar head bearing 472 and a second sonar head bearing 474. In some aspects, the calculated position of the leak 460 can be identified as the center of the angular range 475 for the sector between 472 and 474. In some examples, the calculated position of the leak 460 can be given as the area corresponding to the angular range 475 and the respective range of the measurements 472 and 474. In some cases, the calculated position of the leak 460 can be given as the angle or sonar head bearing that is within the angular range of sector 475, where the strongest readings were obtained and/or where the leak detection confidence level is the greatest, etc.

In some cases, the lander apparatus 405 may be recovered and then redeployed. For example, the lander apparatus 405 can be recovered to change or recharge its onboard battery system, and can then be re-deployed to the same seafloor environment. The location of the lander apparatus 405 prior to recovery can be different from the location of the lander apparatus 405 after being re-deployed. In some aspects, should the lander apparatus 405 be recovered, the lander apparatus 405 can be quickly re-deployed and can geo-reference itself relative to the known locations of the plurality of marker buoys 445 (e.g., 445-01, 445-2, 445-3, . . . , etc.), as the marker buoys 445 do not change location during the recovery and redeployment of the lander apparatus 405.

FIG. 5 is a block diagram illustrating an example of leakage detection, monitoring, and reporting by an onboard processing system 510 of a seafloor lander apparatus 500, in accordance with some examples.

In some embodiments, the seafloor lander apparatus 500 can be the same as the seafloor lander apparatus 300 of FIG. 3 and/or the seafloor lander apparatus 405 of FIG. 4. In some aspects, the lander onboard processing system 510 can be the same as or similar to a lander onboard processing system included in the seafloor lander apparatus 300 of FIG. 3 and/or the seafloor lander apparatus 405 of FIG. 4. For example, the lander onboard processing system 510 can be included within the housing 310 of the seafloor lander apparatus 300 of FIG. 3.

The lander onboard processing system 510 can include one or more machine learning/artificial intelligence (ML/AI) engines 512 and a sensor data analysis logic 514, which may be utilized to process and analyze acoustic sonar scan data and/or chemical measurement data (e.g., obtained by the seafloor lander apparatus) in order to thereby detect and/or monitor one or more leaks in the surrounding seafloor environment associated with the deployed seafloor lander 500. In some aspects, the ML/AI engines 512 can be trained to learn to discriminate bubbles and other indications of underwater leaks from various other underwater objects or sonar signatures that may be encountered by the lander 500. For example, the ML/AI engines 512 can be trained to reject false positives corresponding to sonar signatures of fish, fishing gear, debris, etc., that may be measured within the survey field or view of the scanning sonar of the seafloor lander 500. In some cases, the false positive rejection can be performed based on temporal characteristics within the sonar scan data, based on spatial characteristics within the sonar scan data, and/or based on various combinations of temporal and spatial characteristics within the sonar scan data. For example, temporal characteristics can include the movement of a detected object within the sonar scan data and patterns that are seen over time. The movement pattern(s) of bubbles of gas released by an underwater leak can be different from the movement pattern(s) of individual fish and schools of fish or other marine wildlife. Similarly, bubbles of gas may exhibit a movement pattern that varies on a shorter time scale than the movement pattern (if any) exhibited by man-made underwater objects such as crab pots or other fishing gear that may be placed and removed within the field of view of the scanning sonar of the lander apparatus 500. Spatial characteristics that can be used for false positive rejection in the leak detection performed by the ML/AI engines 512 can include the typical dispersion patterns or shapes of bubbles of gas or hydrocarbons that are escaping, venting, or otherwise being released from an underwater leak. For example, bubbles of a leak may often be oriented in a relatively narrow and long vertical shape. Underwater leaks may also exhibit pluming and/or belching behaviors, which represent combinations of spatial and temporal characteristics that may be used to uniquely identify a detected leak and reject false positives from other objects within the sonar scan survey scene.

The lander onboard processing system 510 can further include a control system 510, a georeferencing system 516, and an event notification system 518. In some aspects, the control system 510 can be associated with functionalities such as deployment leveling (e.g., using the adjustable length legs 362 of FIG. 3), rotation of the acoustic scanning sonar 350 and/or the rotating shaft/panning table 330 of FIG. 3, recovery operations of the lander and control of one or more acoustic releases included in the lander, etc. The georeferencing system 516 can be used to perform georeferencing and position/location estimation or determination for the seafloor lander 500, based on relative positioning to the marker buoys 445 and/or an observed leak 460 of FIG. 4. In one illustrative example, the georeferencing system 516 can be used to implement the various positioning and georeferencing functionalities described above with respect to FIG. 4. The event notification system 518 can be used to provide communications between the seafloor lander 500 and the surface, for example using the communication system 306 and one or more of the various communication techniques, implementations, embodiments, etc., described above for seafloor lander to surface communications. The event notification system 518 can generate and transmit notifications indicative of detected leaks, detected changes in known leaks, raw acoustic sonar and/or chemical measurement data, processed acoustic sonar and/or chemical measurement data, leak prediction information from the ML/AI engines 512, leak analysis, characterization or quantification information from the sensor data analysis logic 514 or ML/AI engines 512, etc.

At initial deployment of the lander 500 (e.g., prior to first performing the periodic scans at block 522), the lander 500 can perform an automatic leveling process. For example, the automatic leveling process can correspond to the deploy leveling 640 of the lander apparatus 600 of FIG. 6, which may be the same as or similar to one or more of the seafloor lander apparatus 300 of FIG. 3, the seafloor lander apparatus 405 of FIG. 4, the seafloor lander apparatus 500 of FIG. 5, etc.

Upon deployment of the lander 500 to the seafloor surface, the lander onboard processing system 510 and/or control system 515 can be used to automatically level the lander 500. In some aspects, automatically leveling the lander includes the slope compensation described with respect to FIG. 3. Automatically leveling the lander can comprise leveling the sensors provided on the lander for leak detection and monitoring (e.g., leveling the acoustic scanning sonar 350 of FIG. 3, etc.), which may or may not be the same as leveling the lander housing, chassis, frame, etc., itself.

After completing the automatic leveling process, the control system 515 of the lander onboard processing system 510 can conduct an initial acoustic scan (e.g., using the acoustic scanning sonar 350 of FIG. 3) to locate all observable marker buoys (e.g., the plurality of marker buoys 445 of FIG. 4, including the individual geo-referenced marker buoys 445-1, 445-2, 445-3, . . . , etc.).

For example, the initial acoustic scan can be performed at block 522. The location of observable marker buoys can correspond to block 524, where the lander 500 is configured to automatically detect two or more marker buoys to thereby determine the lander position and orientation at block 526 (e.g., using the geo-referenced marker buoy location information, and the sonar ranging and encoder angle, heading, or bearing information of the sonar head, as described previously above).

In some aspects, the geo-referenced marker buoy 445 locations can be provided to the lander onboard processing system 510 prior to deployment (e.g., onboard a surface vessel used to deploy the lander 500 and/or the plurality of marker buoys, etc.). In some embodiments, the geo-referenced marker buoy 445 locations can be provided to the lander onboard processing system 510 via acoustic communication from the surface vessel, after deployment of the lander 500 to the seafloor surface. For example, the geo-referenced locations for each marker buoy 445 can be provided to the lander 500 after deployment based on acoustic communications from the surface vessel to the communication system 306 of FIG. 3, the communication system 670 of FIG. 6, etc.

In some aspects, the lander onboard processing system 510 can cause the seafloor lander 500 to perform periodic 360-degree scans at block 522. Each scan can rotate the scanning acoustic sonar head 350 through the full 360 degrees of rotation, at a configurable or adjustable rotation rate or speed. A single scan can comprise one full rotation of the sonar head over the full 360-degrees (or one full traversal of a specified sector that is a subset of the full 360-degrees). The periodic 360-degree scans can be performed in scanning or surveying cycles, where each cycle includes one or more scans. In some aspects, the periodic scans (and periodic cycles of one or multiple scans) performed by the lander apparatus 500 at block 522 can be based on the control system 515 controlling the rotation mechanism or electric motor coupled to and configured to drive the rotation shaft/panning table 330 of FIG. 3. In some examples, the rotation mechanism can be the same as or similar to the rotation mechanism 620 of the lander apparatus 600 of FIG. 6 (e.g., which can be the same as the lander apparatus 500 of FIG. 5, etc.).

For example, one or multiple 360-degree scans can be performed per cycle, over a fixed azimuth range and a set rotation speed. In some embodiments, each sonar scan can correspond to approximately 45 seconds to 1 minute per 360-degree rotation, although a shorter or longer scan duration (and corresponding faster or slower rotation speed) can also be utilized without departing from the scope of the present disclosure. In some examples, each scanning cycle can comprise three or more scans, for a cycle length of approximately three minutes.

In one illustrative example, the lander onboard processing system 510 and/or lander control system 515 can cause the lander 500 to enter a low-power mode or sleep state outside of the configured, periodic scans and scanning cycles performed at block 522. For example, the lander 500 may exit the sleep state to begin performing a scanning cycle of three 1-minute scans, and may return to the sleep state after completing the scanning cycle. A scanning cycle can also be referred to as a wake cycle of the lander 500. In some examples, the lander apparatus 500 may be configured to perform active, periodic scanning cycles 522 during approximately 5% of the time, while remaining in the low power mode or sleep state for the remaining 95% of the time. In some examples, the lander apparatus 500 can be configured to perform one scanning cycle every hour, every 75 minutes, every hour, every 2 hours, etc. The periodicity of scanning cycles (e.g., the periodicity of wake/sleep states at the lander 500) can be configurable by a user, and/or can be configurable and adjustable by the lander onboard processing system 510 itself. In some embodiments, the duration of each individual scan, the number of scans per wake cycle, the periodicity of wake/sleep cycles, etc., can be configured based at least in part on a power management logic implemented by the lander onboard processing system 510. For example, as the remaining power stored in the onboard battery system of the lander 500 is depleted, the lander 500 may decrease its scan duration, may decrease the number of scans per wake cycle, and/or may increase the time between wake cycles (e.g., increase the length of the sleep state between wake cycles).

The power management logic can be included in a battery and power management system of the lander apparatus 500 that is the same as or similar to the battery and power management 610 of FIG. 6. In some cases, the duration of each individual scan, the number of scans per wake cycle, the periodicity of wake/sleep cycles, etc., performed by the lander at block 522 can be configured based at least in part on power state information and/or power management controls or configurations implemented using the battery and power management logic 610 of FIG. 6.

After the initial scan to auto-detect two or more marker buoys at block 524, and determine a geo-referenced location of the lander 500 and orientation (e.g., heading, bearing, angle, etc.) of the sonar head of the lander 500 at block 526, the lander apparatus 500 can enter normal operation to periodically monitor for and detect one or more leaks and/or changes to baseline or known leaks.

For example, in normal operation, the acoustic scans are periodically performed at block 522, according to a configured cadence or periodicity of the wake/sleep scanning interval as described above. In each surveying scan during normal operation of the lander 500, the marker buoys 445 should remain visible in the sonar sensor scan data. In some embodiments, the lander apparatus 500 may optionally use the marker buoys 445 to confirm the current location and orientation of the sonar head for some (or all) of the subsequent scans performed during normal operation at block 522.

At block 528, the sonar scan data can be analyzed in-situ and onboard the lander 500, without external communications to the surface or to any remote devices or locations. For example, the sonar scan data can be analyzed in-situ and onboard the lander apparatus 500, using the ML/AI engine 512 and/or sensor data analysis logic 514 of the lander onboard processing system 510. The ML/AI engine 512 or sensor data analysis logic 514 can be configured to detect signs of leaks or changes in the marine environment surrounding the lander 500 in its deployed location on the seafloor surface. In some aspects, the analysis of the scanned sonar data for leakage can be performed at block 528 using a combination of algorithmic techniques (e.g., corresponding to sensor data analysis logic 514) and machine learning techniques (e.g., corresponding to the ML/AI engine 512).

At block 530 of a wake cycle/scanning cycle of the lander apparatus 500 during normal operation, a determination can be made as to whether a leakage was identified in the scanned sonar data. If a leakage is not identified, or if a change is not observed, the system may enter the low power or sleep mode state and wait for the configured sleep duration before waking to perform the next scan cycle (e.g., corresponding to the ‘No’ branch of decision block 530). If a leakage is identified, or if a change is observed, the system does not enter the sleep state and instead proceeds to block 532 via the ‘Yes’ branch of decision block 530.

In some embodiments, the determination at block 530 of whether a leakage or change is identified can be implemented based on one or more configured thresholds. For example, the configured threshold can be a configured confidence level threshold, wherein detecting a leakage requires a confidence level greater than or equal to the configured threshold value. In some cases, the same threshold can be used to detect or not detect a leak. In some cases, a leak may be detected based on the confidence level being greater than or equal to a first threshold, and a leak is not detected based on the confidence level being less than a second threshold that is different from the first threshold. The confidence level associated with a potential leakage detection can be generated as an additional output of the ML/AI engine 512 and/or sensor data analysis logic 514 that is used to determine the potential leakage detection in question.

Based on a determination that a leak is identified in the analysis of the scanned sonar data by the lander onboard processing system 510, the size and location of the leakage can be estimated at block 532. For example, additional computations and/or analysis may be performed to determine the volume of the leak, the flow rate of the leak, the bubble size of the leak, etc. In some cases, when the identified leakage is a change to a known or baseline leak, block 532 can include using the ML/AI engine 512 to identify and qualify (e.g., quantify) the changes in the leak behaviors or characteristics.

In some embodiments, the lander onboard processing system 510 can be configured to additionally perform periodic chemical analysis of the water column to look for leaks. In some examples, the periodicity of the chemical analysis performed at block 542 can be the same as the periodicity of the sonar scans of block 522. In some aspects, the periodicity of the chemical analysis of block 542 can be different from the periodicity of the sonar scans of block 522. In some examples, the periodicity of sonar scans 522 and chemical measurements 542 may differ, and the sonar scans 522 and chemical measurements 542 are performed within the same wake cycle. In some cases, the lander 500 may wake from the low power sleep state to perform only one of either the periodic sonar scans 522 or the periodic chemical measurements 542. In some examples, the periodic sonar scans 522 and the periodic chemical measurements 542 can be performed in parallel (e.g., simultaneously). In some examples, the periodic sonar scans 522 and the periodic chemical measurements 542 may be perform sequentially.

In some embodiments, the periodic chemical analysis for leakage performed at block 542 of FIG. 5 can be implemented using one or more chemical measurement sensors that are the same as or similar to the chemical sensor(s) 660 of FIG. 6, and/or any other chemical sensors described herein.

At block 544, the chemical sensor measurements obtained at block 542 from the chemical sensors 660 can be analyzed to determine if a leakage is identified or indicated based on the chemical measurements. In some aspects, the chemical sensor measurements can be analyzed by the same ML/AI engine 512 and/or sensor data analysis logic 514 that is used to analyze the acoustic sonar scan data to identify, detect, and/or monitor leaks at block 530. For instance, the ML/AI engine 512 can be configured to operate on inputs comprising both acoustic sonar scan data and chemical sensor measurement data, and/or can be configured to operate on only one of acoustic sonar scan data or chemical sensor measurement data. In some examples, the chemical sensor measurements can be analyzed by a different or separate ML/AI engine 512 from the ML/AI engine 512 that is used to analyze the acoustic sonar scan data. For example, the lander onboard processing system 510 can include one or more ML/AI engines 512 that are trained to perform leakage detection and monitoring based on and using only acoustic sonar data, one or more ML/AI engines 512 that are trained to perform leakage detection and monitoring based on and using only chemical sensor measurement data, and/or can include one or more ML/AI engines 512 that are implemented as multi-modal models that are trained on a combination of acoustic sonar scan data and chemical sensor measurement data to perform leakage detection and monitoring.

If a leakage is identified at block 544, based on the chemical sensor measurements obtained at block 542, the leakage can be tracked and monitored for changes at block 535. Similarly, if a leakage is identified at block 530, based on the acoustic sonar scan data obtained at block 522, the leakage can be tracked and monitored for changes at block 535. A leakage identified by both sonar scans 522 and chemical measurement sensor data 542 can be tracked as a single leakage with multiple detection or monitoring modalities, at the leak tracking and change monitoring block 535 implemented by the lander onboard processing system 510. In some aspects, the leak tracking and change monitoring block 535 can be implemented using the ML/AI engines 512 and/or the sensor data analysis logic 514 that was used to originally identify the leak(s) at block 530 (e.g., sonar-identified leak) and/or at block 544 (e.g., chemical-identified leak).

In some embodiments, at block 552, the lander onboard processing system 510 can use the event notification system 518 to report (e.g., to the surface, to a control center or operations center, a surface vessel, etc.) information indicative of or corresponding to a detected leakage and/or changes in a detected leakage. The reporting of detected leakages and/or changes to known leakages performed at block 552 of FIG. 5 can be implemented using the communication system to the surface 670 included in the lander apparatus 600 of FIG. 6, which can be the same as or similar to the lander apparatus 500 of FIG. 5.

The event notification system 518 can be configured to report leaks that are above a threshold value for one or more parameters or characteristics determined for the leak. For example, the estimated size and location of a detected leak determined at block 532 can be compared to one or more threshold values, and may trigger reporting by the event notification system 518 at block 552 based on the threshold values being exceeded. For instance, leaks above a threshold size or flow rate can trigger reporting to the surface, while leaks below the threshold size or flow rate do not trigger reporting to the surface but can be subject to further or increased monitoring at block 554. In another example, leaks within a configured threshold distance of an identified location can trigger reporting to the surface, while leaks outside of the configured threshold distance to the identified location do not trigger reporting immediately, but may be subject to further and/or increased monitoring at block 554. For example, leaks within 10 m of a wellhead can trigger reporting, while leaks beyond 10 m from the wellhead may be potentially erroneous and do not trigger immediate reporting to the surface by the seafloor lander 500.

In some embodiments, after a leak is detected and reported (and/or a change in leakage is detected and reported) at block 552, the lander onboard processing system 510 can cause the seafloor lander 500 to monitor the detected leak with a greater frequency of measurements or surveying, by one or more (or both) of the periodic sonar scans 522 and/or the periodic chemical measurement sensing 542.

For example, with reference to FIG. 4, after detecting the leak 460 or determining that leak 460 has changed beyond a configured threshold amount or value, the lander apparatus 405 can implement the process of block 554 based on performing additional scans within the sector 475 that corresponds to the location or area of the leak 460. For example, the lander apparatus 405 may modify the baseline 360-degree scans to instead scan only within the angular range 475 corresponding to the observed leakage 460. In some cases, the lander apparatus 405 may continue to perform the regular, periodic baseline 360-degree scans of the entire seafloor environment, and may configure one or more additional scans specific to the angular range 475 of the observed leakage 460, at a different periodicity than the regular baseline 360-degree scans. In some cases, the scans performed specific to the observed leakage or change in leakage 460 can be performed with a different number of scans per cycle as compared to the baseline 360-degree scans, and/or can be performed with a different scan duration for each individual scan within the cycle as compared to that of the baseline 360-degree scans.

In some examples, the detection of a leak or change in a known leak above or beyond one or more configured thresholds can cause the lander apparatus to adjust its power management logic to allocate increased battery power to the performance of the additional, leak-specific scans within the angular range 475 corresponding to the observed leakage 460. For example, the power management logic may optimize the power consumption of the additional leak-specific scans against the remaining battery life of the lander, where greater priority is given to the additional leak-specific scans for higher severity leaks, larger leaks, leaks with greater uncertainty, etc.

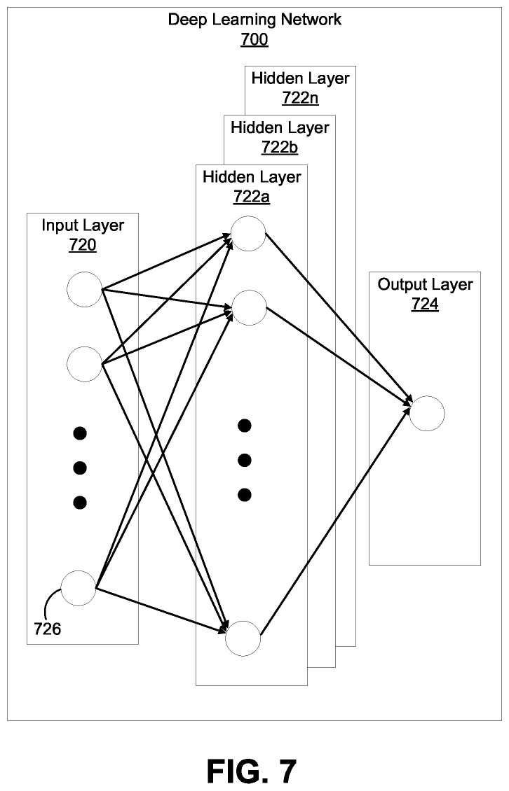

FIG. 7 is an illustrative example of a deep learning (DL) neural network 700 that in some examples can be used to implement one or more machine learning networks and/or machine learning architectures, including those associated with the ML/AI engines 512 of FIG. 5 and/or associated with the presently disclosed seafloor lander apparatus of FIGS. 3-6 that can be used for in-situ, onboard leak detection, monitoring, and/or analysis at the seafloor surface.

An input layer 720 includes input data. In one illustrative example, the input layer 720 can include data representing the pixels of an input video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n. In one illustrative example, the output layer 724 can provide a classification for an object in an input video frame. The classification can include a class identifying the type of object (e.g., a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as Eₜₒₜₐₗ=Σ½(target−output)², which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

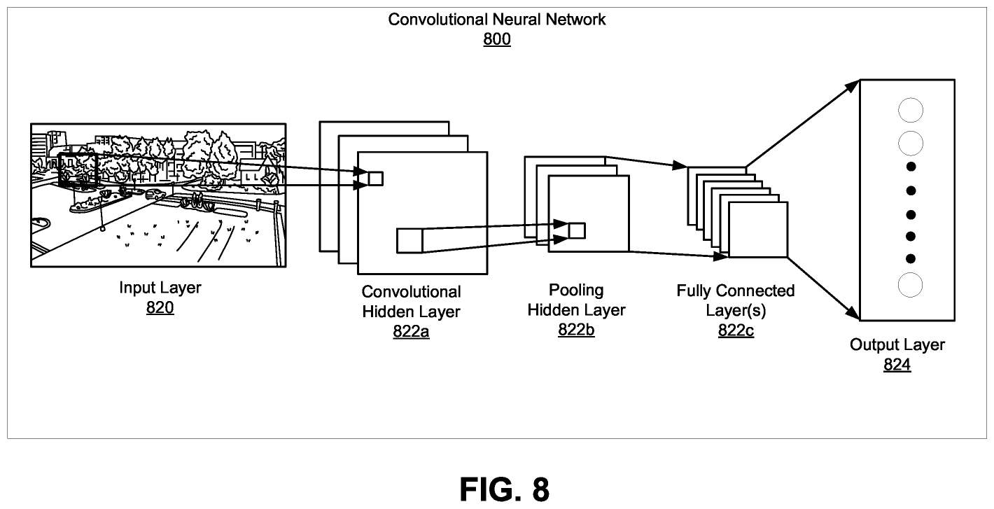

The neural network 700 can include any suitable deep network. One example includes a convolutional neural network (CNN), which includes an input layer and an output layer, with multiple hidden layers between the input and out layers. An example of a CNN is described below with respect to FIG. 8. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is an illustrative example of a convolutional neural network 800 (CNN 800). In some aspects, the CNN 800 can be used to implement one or more machine learning networks and/or machine learning architectures, including those associated with the one or more ML/AI models and/or functionalities for UE-side beam prediction described herein. In example implementations where the CNN 800 is configured to perform ML/AI-based beam prediction at a UE, the input layer 820 of the CNN 800 may include and/or receive data representing one or more beam measurements. In the example of FIG. 8, the input layer 820 of the CNN 800 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 822a, an optional non-linear activation layer, a pooling hidden layer 822b, and fully connected hidden layers 822c to get an output at the output layer 824. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 is the convolutional hidden layer 822a. The convolutional hidden layer 822a analyzes the image data of the input layer 820. Each node of the convolutional hidden layer 822a is connected to a region of nodes (pixels) of the input image called a receptive field. The convolutional hidden layer 822a can be considered as one or more filters (each filter corresponding to a different activation or feature map), with each convolutional iteration of a filter being a node or neuron of the convolutional hidden layer 822a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 822a. Each connection between a node and a receptive field for that node learns a weight and, in some cases, an overall bias such that each node learns to analyze its particular local receptive field in the input image. Each node of the hidden layer 822a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 822a is due to each node of the convolutional layer being applied to its corresponding receptive field. For example, a filter of the convolutional hidden layer 822a can begin in the top-left corner of the input image array and can convolve around the input image. As noted above, each convolutional iteration of the filter can be considered a node or neuron of the convolutional hidden layer 822a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 822a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 822a.

The mapping from the input layer to the convolutional hidden layer 822a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 822a can include several activation maps in order to identify multiple features in an image. The example shown in FIG. 8 includes three activation maps. Using three activation maps, the convolutional hidden layer 822a can detect three different kinds of features, with each feature being detectable across the entire image.

In some examples, a non-linear hidden layer can be applied after the convolutional hidden layer 822a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 822a.

The pooling hidden layer 822b can be applied after the convolutional hidden layer 822a (and after the non-linear hidden layer when used). The pooling hidden layer 822b is used to simplify the information in the output from the convolutional hidden layer 822a. For example, the pooling hidden layer 822b can take each activation map output from the convolutional hidden layer 822a and generates a condensed activation map (or feature map) using a pooling function. Max-pooling is one example of a function performed by a pooling hidden layer. Other forms of pooling functions be used by the pooling hidden layer 822a, such as average pooling, L2-norm pooling, or other suitable pooling functions. A pooling function (e.g., a max-pooling filter, an L2-norm filter, or other suitable pooling filter) is applied to each activation map included in the convolutional hidden layer 822a. In the example shown in FIG. 8, three pooling filters are used for the three activation maps in the convolutional hidden layer 822a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 822a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 822a having a dimension of 24×24 nodes, the output from the pooling hidden layer 822b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 822b to every one of the output nodes in the output layer 824. Using the example above, the input layer includes 28×28 nodes encoding the pixel intensities of the input image, the convolutional hidden layer 822a includes 3×24×24 hidden feature nodes based on application of a 5×5 local receptive field (for the filters) to three activation maps, and the pooling layer 822b includes a layer of 3×12×12 hidden feature nodes based on application of max-pooling filter to 2×2 regions across each of the three feature maps. Extending this example, the output layer 824 can include ten output nodes. In such an example, every node of the 3×12×12 pooling hidden layer 822b is connected to every node of the output layer 824.

The fully connected layer 822c can obtain the output of the previous pooling layer 822b (which should represent the activation maps of high-level features) and determines the features that most correlate to a particular class. For example, the fully connected layer 822c layer can determine the high-level features that most strongly correlate to a particular class, and can include weights (nodes) for the high-level features. A product can be computed between the weights of the fully connected layer 822c and the pooling hidden layer 822b to obtain probabilities for the different classes. For example, if the CNN 800 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 824 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 110% probability that the image is the fourth class of object (e.g., a human), and a 15% probability that the image is the sixth class of object (e.g., a kangaroo). The probability for a class can be considered a confidence level that the object is part of that class.

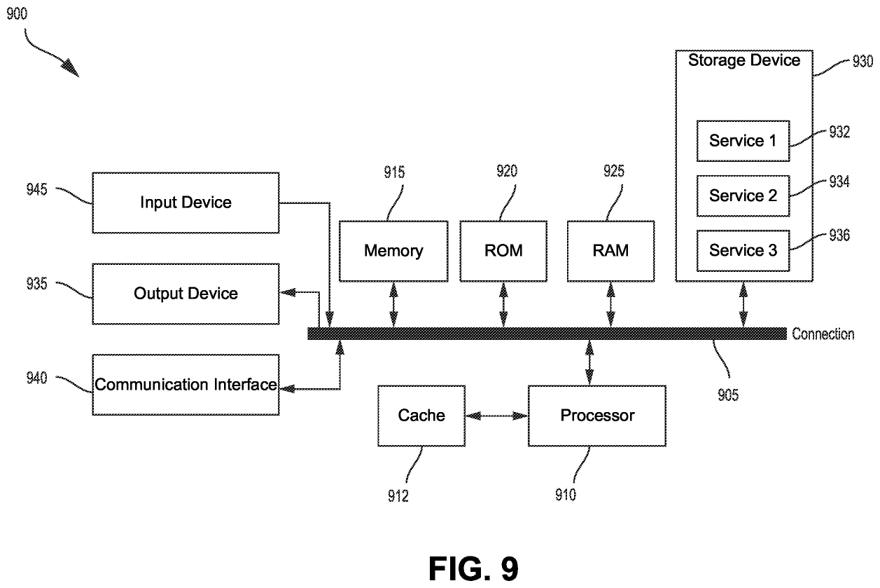

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some aspects, computing system 900 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some aspects, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A method comprising:
determining georeferenced location information of a seafloor lander deployed on a seafloor surface, wherein the georeferenced location information is determined based on respective location information corresponding to two or more marker buoys deployed to the seafloor surface;
obtaining acoustic sensor data from an acoustic sensor rotatably coupled to the seafloor lander, wherein the acoustic sensor is rotated through a configured angular range one or more times;
detecting, using an onboard processing engine of the seafloor lander, one or more gaseous leaks from the seafloor surface, wherein the one or more gaseous leaks are detected based on analyzing the acoustic sensor data using the onboard processing engine of the seafloor lander;
determining a corresponding location of the one or more gaseous leaks, based on the georeferenced location information of the seafloor lander and relative position information between the acoustic sensor and the one or more gaseous leaks; and
transmitting, from the seafloor lander to a surface receiver, leak detection information indicative of the one or more gaseous leaks and the corresponding location.

2. The method of claim 1, wherein detecting the one or more gaseous leaks is performed in-situ at the seafloor surface by the onboard processing engine of the seafloor lander.

3. The method of claim 1, wherein the onboard processing engine of the seafloor lander includes one or more trained machine learning (ML) or artificial intelligence (AI) models trained to perform leak detection.

4. The method of claim 3, further comprising:
determining, using the one or more trained ML or AI models included in the onboard processing engine, a leaked gas volume associated with the one or more gaseous leaks;
obtaining additional acoustic sensor data based on one or more subsequent measurement cycles wherein the acoustic sensor is rotated to sweep through an angular sector corresponding to the location of the one or more gaseous leaks; and
monitoring, based on analyzing the additional acoustic sensor data using the one or more trained ML or AI models, changes to the leaked volume associated with the one or more gaseous leaks.

5. The method of claim 1, wherein detecting the one or more gaseous leaks from the seafloor surface is further based on obtaining chemical measurement sensor data from one or more chemical measurement sensors associated with the seafloor lander.

6. The method of claim 5, wherein a periodicity associated with obtaining the chemical measurement sensor data is different from a periodicity associated with obtaining the acoustic sensor data.

7. The method of claim 1, wherein the acoustic sensor data comprises sonar scan data and the acoustic sensor comprises one or more of a sidescan sonar, a multibeam echosounder (MBES), a scanning sonar, or a volumetric scanning sonar.

8. The method of claim 1, wherein the acoustic sensor data comprises a plurality of measured reflections each corresponding to a sonar pulse transmitted by the acoustic sensor at a respective bearing of the acoustic sensor within the configured angular range, wherein the respective bearing is determined using a rotary encoder associated with the acoustic sensor.

9. The method of claim 1, wherein detecting one or more gaseous leaks includes detecting a change in a leakage quantity or leakage volume associated with a previously detected gaseous leak.

10. The method of claim 1, wherein the acoustic sensor data is obtained within a respective measurement cycle of a plurality of periodic measurement cycles performed using the acoustic sensor of the seafloor lander.

11. The method of claim 10, wherein the seafloor lander enters a low-power mode or sleep state between consecutive measurement cycles of the plurality of periodic measurement cycles.

12. The method of claim 10, further comprising one or more of:
increasing a duration of the plurality of periodic measurement cycles in response to the onboard processing engine detecting the one or more gaseous leaks; or
reducing the configured angular range for the acoustic sensor to a sector corresponding to the determined location of the one or more gaseous leaks, wherein the sector comprises a subset of the configured angular range

13. The method of claim 1, wherein:
the georeferenced location information of the seafloor lander comprises a location coordinate and an orientation of the acoustic sensor; and
the corresponding location of the one or more gaseous leaks is determined based on combining the georeferenced location information with the relative position information.

14. The method of claim 13, wherein the orientation of the acoustic sensor comprises an angular offset relative to one or more of the marker buoys, and wherein the angular offset is associated with a range or distance measurement determined between the acoustic sensor and the one or more of the marker buoys.

15. The method of claim 1, wherein the relative position information between the acoustic sensor and the one or more gaseous leaks comprises:
a range determined based on the acoustic sensor data and corresponding to a distance from the acoustic sensor to the one or more gaseous leaks; and
a relative bearing associated with the range.

16. The method of claim 15, wherein the relative bearing associated with the range comprises one or more of:
an angular orientation of the acoustic sensor at a time when the range is measured; or
an angular offset from one or more of the marker buoys at a time when the range is measured.

17. The method of claim 1, wherein the leak detection information is transmitted acoustically by an acoustic modem of the seafloor lander to a surface buoy.

18. The method of claim 1, wherein transmitting the leak detection information comprises:
transmitting the leak detection information over a wired communication link between the seafloor lander and a tethered surface buoy, wherein the wired communication link comprises a tether coupled at a first end to the seafloor lander and coupled at a second end to the tethered surface buoy; and
relaying the leak detection information over a wireless communication link from the tethered surface buoy.

19. A seafloor lander apparatus for in-situ leak detection, the apparatus comprising:
at least one processor; and
a memory storing instructions which when executed by the at least one processor, causes the at least one processor to:
determine georeferenced location information of the seafloor lander apparatus deployed on a seafloor surface, wherein the georeferenced location information is determined based on respective location information corresponding to two or more marker buoys deployed to the seafloor surface;
obtain acoustic sensor data from an acoustic sensor rotatably coupled to the seafloor lander apparatus, wherein the acoustic sensor data is obtained based on rotating the acoustic sensor through a configured angular range one or more times;
detect, using an onboard processing engine of the seafloor lander apparatus, one or more gaseous leaks from the seafloor surface, wherein the one or more gaseous leaks are detected based on analyzing the acoustic sensor data using the onboard processing engine;
determine a corresponding location of the one or more gaseous leaks, based on the georeferenced location information and relative position information between the acoustic sensor and the one or more gaseous leaks; and
transmit, from the seafloor lander apparatus to a surface receiver, leak detection information indicative of the one or more gaseous leaks and the corresponding location.

20. The seafloor lander apparatus of claim 19, wherein the at least one processor is further configured to:
determine, using one or more trained machine learning (ML) or artificial intelligence (AI) models included in the onboard processing engine, a leaked gas volume associated with the one or more gaseous leaks;
obtain additional acoustic sensor data based on one or more subsequent measurement cycles wherein the acoustic sensor is rotated to sweep through an angular sector corresponding to the location of the one or more gaseous leaks; and
monitor, based on analyzing the additional acoustic sensor data using the one or more trained ML or AI models, changes to the leaked volume associated with the one or more gaseous leaks.
